(19) United States
(12) Patent Application Publication
(10) Pub. No.: US 2024/0129036 A1
(43) Pub. Date: Apr. 18, 2024

(54) TRANSMITTER, TRANSMISSION DEVICE, COMMUNICATION DEVICE, AND COMMUNICATION SYSTEM

(71) Applicant: NEC Corporation, Tokyo (JP)

(72) Inventors: Fujio OKUMURA, Kanagawa (JP); Hiroshi Imai, Tokyo (JP)

(73) Assignee: NEC Corporation, Tokyo (JP)

(21) Appl. No.: 18/371,049

(22) Filed: Sep. 21, 2023

(30) Foreign Application Priority Data
Oct. 13, 2022 (JP) 2022-164678

(51) Int. Cl. H04B 10/50; G02B 17/06; G02B 27/00; H04B 10/11

(52) U.S. Cl. CPC H04B 10/50; G02B 17/0673; G02B 27/0018; H04B 10/11

(57) ABSTRACT

Transmitter that includes a light source, a spatial light modulator including a modulation part that modulates illumination light emitted from the light source, a first mirror that is arranged on a first optical path of the modulated light modulated by the modulation part and reflects the modulated light toward a first projection range, and a second mirror that is arranged on a second optical path of the modulated light modulated by the modulation part and reflects the modulated light toward a second projection range around the first projection range. The first mirror and the second mirror are disposed at positions deviated from an optical path of unnecessary light included in the modulated light.

This application is based upon and claims the benefit of priority from Japanese Patent Application No. 2022-164678, filed on Oct. 13, 2022, the disclosure of which is incorporated herein in its entirety by reference.

### TECHNICAL FIELD

The present disclosure relates to a transmitter or the like that transmits an optical signal propagating in a space.

### BACKGROUND ART

In optical space communication, communication using optical signals (hereinafter, spatial light signals) propagating in a space is performed without using a medium such as an optical fiber. In order to transmit the spatial light signal in a wide range, it is preferable that the projection angle of the projection light is as wide as possible. For example, the projection angle can be widened by controlling the pattern set in the modulation part of the spatial light modulator by using a light transmission device including a phase modulation-type spatial light modulator. If the spatial light signal can be transmitted in a plurality of directions around the light transmission device, a communication network using the spatial light signal can be constructed.

Patent Literature 1 (WO 2018/056194 A) discloses a projection system including a phase modulation-type spatial light modulation element. Patent Literature 1 A includes a projection means, a control means, and a reflecting mirror. The projection means includes a light source, a spatial light modulator, and an optical system. The spatial light modulation element is a phase modulation-type element and includes a display unit that displays a pattern corresponding to the display information. The spatial light modulation element emits modulated light of the light emitted from the light source to the display unit. The optical system projects the modulated light emitted from the spatial light modulation element. The control means generates a control condition for controlling the light source and the spatial light modulation element on the basis of the display condition acquired from the host system. The control means controls the light source and the spatial light modulation element on the basis of the generated control condition. The reflecting mirror reflects the projection light of the projection means toward the plurality of display regions.

According to the method of Patent Literature 1, display information with sufficient brightness can be projected on a plurality of display regions without distortion by distortion correction using a reflecting mirror. For example, when a reflecting mirror (curved mirror) having a curved reflecting surface projecting in the projection direction is used, the projection angle of the projection light can be increased according to the curvature of the reflecting surface. The projection angle can be increased by increasing the curvature of the reflecting surface of the curved mirror. However, when the curved mirror is used, the effective communication distance decreases due to diffusion of the projection light as the curvature of the reflecting surface increases.

An object of the present disclosure is to provide a transmitter or the like capable of extending an effective communication distance of a spatial light signal while securing a sufficient projection range.

### SUMMARY

A transmitter according to one aspect of the present disclosure includes a light source, a spatial light modulator including a modulation part that modulates light emitted from the light source, a first mirror that is arranged on a first optical path of the modulated light modulated by the modulation part and reflects the modulated light toward a first projection range, and a second mirror that is arranged on a second optical path of the modulated light modulated by the modulation part and reflects the modulated light toward a second projection range around the first projection range, in which the first mirror and the second mirror are arranged at positions deviated from an optical path of unnecessary light included in the modulated light.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a transmission device in this according to a first example embodiment;

FIG. 2 is a conceptual diagram illustrating an arrangement example of mirrors included in the transmission device according to the first example embodiment;

FIG. 3 is a conceptual diagram illustrating an arrangement example of mirrors included in the transmission device according to the first example embodiment;

FIG. 4 is a conceptual diagram illustrating an example of a projection range of the projection light projected from the transmission device according to the first example embodiment;

FIG. 5 is a conceptual diagram for explaining spread of the projection light projected from the transmission device according to the first example embodiment;

FIG. 6 is a conceptual diagram for explaining spread of the projection light projected from a transmission device according to a comparative example;

FIG. 7 is a conceptual diagram illustrating an example of a configuration of a transmission device according to a second example embodiment;

FIG. 8 is a conceptual diagram illustrating an arrangement example of mirrors included in the transmission device according to the second example embodiment;

FIG. 9 is a conceptual diagram illustrating an arrangement example of mirrors included in the transmission device according to the second example embodiment;

FIG. 10 is a conceptual diagram illustrating an example of a projection range of the projection light projected from the transmission device according to the second example embodiment;

FIG. 11 is a conceptual diagram illustrating an example of a configuration of a transmission device according to a third example embodiment;

FIG. 12 is a conceptual diagram illustrating an arrangement example of mirrors included in the transmission device according to the third example embodiment;

FIG. 13 is a conceptual diagram illustrating an arrangement example of mirrors included in the transmission device according to the third example embodiment;

FIG. 14 is a conceptual diagram illustrating an example of a projection range of the projection light projected from the transmission device according to the third example embodiment;

FIG. 15 is a conceptual diagram illustrating an example of a configuration of a transmission device according to the third example embodiment;

FIG. 16 is a conceptual diagram illustrating an arrangement example of mirrors included in the transmission device according to the third example embodiment;

FIG. 17 is a conceptual diagram illustrating an example of a projection range of the projection light projected from the transmission device according to the third example embodiment;

FIG. 18 is a conceptual diagram illustrating an example of a configuration of a transmission device according to a fourth example embodiment;

FIG. 19 is a conceptual diagram illustrating an arrangement example of mirrors included in the transmission device according to the fourth example embodiment;

FIG. 20 is a conceptual diagram illustrating an arrangement example of mirrors included in the transmission device according to the fourth example embodiment;

FIG. 21 is a conceptual diagram illustrating an example of a projection range of the projection light projected from the transmission device according to the fourth example embodiment;

FIG. 22 is a conceptual diagram illustrating an example of a configuration of a communication device according to a fifth example embodiment;

FIG. 23 is a conceptual diagram illustrating an example of a configuration of a reception device included in a communication device according to the fifth example embodiment;

FIG. 24 is a conceptual diagram illustrating an example of a configuration of a communication device according to an application example of the fifth example embodiment;

FIG. 25 is a conceptual diagram illustrating an example of a communication system including a communication device according to an application example of the fifth example embodiment;

FIG. 26 is a conceptual diagram illustrating an example of a configuration of a transmitter according to a sixth example embodiment; and

FIG. 27 is a conceptual diagram illustrating an example of a hardware configuration that executes control and processing according to each example embodiment.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, the directions of the arrows in the drawings are merely examples, and do not limit the directions of light and signals. The line indicating the trajectory of light in the drawings is conceptual, and does not accurately indicate the actual traveling direction or state of light. For example, in the drawings, a change in a traveling direction or a state of light due to refraction, reflection, diffusion, or the like at an interface between air and a substance may be omitted, or a light flux may be expressed by one line. In addition, there is a case where hatching is not applied to the cross-section for reasons such as showing an example of the path of light or the configuration being complicated.

### First Example Embodiment

First, a transmission device according to a first example embodiment will be described with reference to the drawings. The transmission device of the present example embodiment is used for optical space communication in which optical signals (hereinafter, spatial light signals) propagating in a space are transmitted and received without using a medium such as an optical fiber. The transmission device of the present example embodiment may be used for applications other than optical space communication as long as the transmission device transmits light propagating in a space. Note that the drawings used in the description of the present example embodiment are conceptual and do not accurately depict an actual structure.

### Configuration

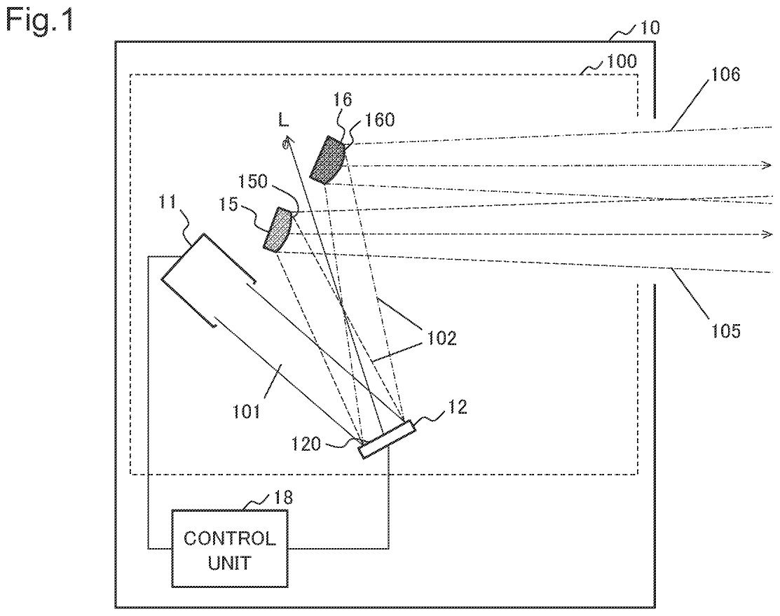

FIG. 1 is a conceptual diagram illustrating an example of a configuration of a transmission device 10 according to the present example embodiment. The transmission device 10 includes a light source 11, a spatial light modulator 12, a first mirror 15, a second mirror 16, and a control unit 18. The light source 11, the spatial light modulator 12, the first mirror 15, and the second mirror 16 constitute a transmitter 100. FIG. 1 is a conceptual diagram of an internal configuration of the transmission device 10 as viewed from a lateral direction. FIG. 1 is conceptual, and does not accurately represent a shape of each component, a positional relationship between components, traveling of light, and the like.

The light source 11 emits illumination light 101 under the control of the control unit 18. The light source 11 includes a light emitter and an optical system associated with the light emitter. The emission surface of the light source 11 is directed to the spatial light modulator 12. The light source 11 emits illumination light 101 toward the spatial light modulator 12. In the present example embodiment, an example in which the light source 11 includes a pair of light emitters and an optical system will be described. The light source 11 may have a plurality of pairs of light emitters and optical systems.

The light emitter included in the light source 11 emits laser light in a predetermined wavelength band under the control of the control unit 18. The wavelength of the laser light emitted from the light emitter is not particularly limited. The wavelength of the laser light may be selected according to the application. For example, the light emitter emits laser light in a visible or infrared wavelength band. For example, near-infrared rays of 800 to 1000 nanometers (nm) can be given a laser class as compared with visible light, so that sensitivity can be improved as compared with visible light. For example, in the case of infrared rays in a wavelength band of 1.55 micrometers (μm), a laser light source having a higher output than near-infrared rays of 800 to 1000 nm can be used. As a laser light source that emits infrared rays in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be made and the higher the energy can be set.

For example, a light emitter included in the light source 11 is achieved by a surface emitting laser. An example of the surface emitting laser is a VCSEL (Vertical-Cavity Surface-Emitting Laser). The VCSEL laser emits laser light of circular radiation. Further, another example of the surface emitting laser is a PCSEL (Photonic Crystal Surface Emitting Laser). The PCSEL laser emits laser light of circular narrow radiation. Compared with the VCSEL laser, the PCSEL laser emits uniform laser light.

For example, a light emitter included in the light source 11 is achieved by a fiber array laser. In the fiber array laser, a laser light source and an emission unit (optical system) are connected by an optical waveguide (optical fiber). The laser light emitted from the laser light source is emitted from the emission unit through the waveguide. When the fiber array type laser is used, the laser light source and the emission unit can be arranged at different positions. Therefore, if the fiber array type laser is used, the light emitter can be arranged at a position away from the spatial light modulator 12, so that thermal interference hardly occurs even if the spatial light modulator 12 and the light emission unit are brought close to each other.

The optical system included in the light source 11 is arranged in association with the light emitter. The optical system converts the laser light emitted from the light emitter into illumination light 101. The converted illumination light 101 is emitted from the light source 11. The illumination light 101 emitted from the light source 11 travels toward the spatial light modulator 12. Note that the optical system may be omitted depending on a positional relationship, a distance, a use condition, and the like between the light source 11 and the spatial light modulator 12.

The spatial light modulator 12 is a two-dimensional phase modulator. The spatial light modulator 12 includes a modulation part 120 that modulates the emitted light. The spatial light modulator 12 of the present example embodiment includes a reflection-type modulation part 120. At least one modulation region is set in the modulation part 120. In the example of FIG. 1, the first mirror 15 and the second mirror 16 are arranged at a subsequent stage of the spatial light modulator 12. For all the reflecting surfaces of the first mirror 15 and the second mirror 16, a common modulation region may be set, or different modulation regions may be allocated. The modulation part 120 in which the modulation region is set is irradiated with the illumination light 101 emitted from the light source 11.

In the modulation region set in the modulation part 120, a pattern (phase image) corresponding to the image displayed by the projection lights 105 to 106 is set according to the control of the control unit 18. The illumination light 101 incident on the modulation region set in the modulation part 120 is modulated according to the pattern (phase image) set in the modulation region. The modulated light 102 modulated in the modulation region travels toward the first mirror 15 and the second mirror 16 disposed at a subsequent stage.

The modulation region set in the modulation part 120 is divided into a plurality of regions (tiling). For example, the modulation region is divided into regions (tiles) of a desired aspect ratio. A phase image is assigned to each of the plurality of tiles set in the modulation region. Each of the plurality of tiles includes a plurality of pixels. A phase image corresponding to the projected image is set to each tile. A phase image is tiled to each tile assigned to the modulation region. For example, a phase image generated in advance is set in each tile according to an image displayed by projection light. As the number of tiles set in the modulation region increases, a clear image can be displayed. On the other hand, as the number of tiles increases, the resolution decreases as the number of pixels of each tile decreases. Therefore, the size and number of tiles set in the modulation region are set according to the application.

When the modulation region is irradiated with the illumination light 101 in a state where the phase image is set to the plurality of tiles, the modulated light 102 that forms an image corresponding to the phase image of each tile is emitted. The modulated light 102 includes 0th-order light L₀. The modulated light 102 also includes unnecessary light components. The 0th-order light L₀ travels toward a region (dead region) between the first mirror 15 and the second mirror 16.

For example, the spatial light modulator 12 is achieved by a spatial light modulator using ferroelectric liquid crystal, homogeneous liquid crystal, vertical alignment liquid crystal, or the like. For example, the spatial light modulator 12 can be achieved by liquid crystal on silicon (LCOS). Furthermore, the spatial light modulator 12 may be achieved by a micro electro mechanical system (MEMS). In the phase modulation-type spatial light modulator 12, the energy can be concentrated on the portion of the image by operating to sequentially switch the portion on which the projection light 105 is projected. Therefore, in the case of using the phase modulation-type spatial light modulator 12, if the output of the light source 11 is the same, the image can be displayed brighter than other methods.

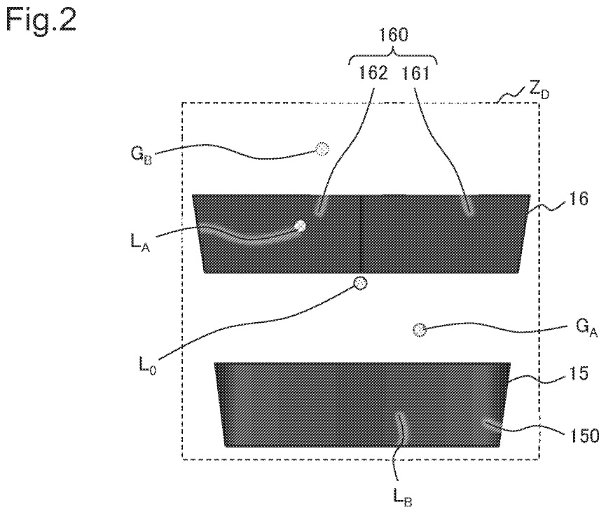

FIG. 2 is a conceptual diagram illustrating a positional relationship between the first mirror 15 and the second mirror 16. FIG. 2 is a conceptual diagram of the first mirror 15 and the second mirror 16 as viewed from the reflecting surface side. The first mirror 15 has a reflecting surface 150. The second mirror 16 has a reflecting surface 160. The reflecting surface 160 is divided into a reflecting surface 161 and a reflecting surface 162. FIG. 2 illustrates an example in which the second mirror 16 is disposed above the first mirror 15. The second mirror 16 may be disposed below the first mirror 15. FIG. 2 illustrates a region (dead region Z_{D}) where the modulated light 102 is not reflected around the first mirror 15 and the second mirror 16. A region not illustrated in the peripheral regions of the first mirror 15 and the second mirror 16 is also included in the dead region Z_{D}.

FIG. 2 illustrates an example of positions irradiated with the 0th-order light L₀, the desired light L_{A}, the desired light L_{B}, the ghost image G_{A}, and the ghost image G_{B}. The 0th-order light L₀ is 0th-order diffracted light included in the modulated light 102. The desired light L_{A} and the desired light L_{B} are first-order diffracted light included in the modulated light 102. The desired light L_{A} and the desired light L_{B} are light to be projected. The ghost image G_{A} is light that appears at a point-symmetrical position with respect to the desired light L_{A} with the 0th-order light L₀ as the center. The ghost image G_{B} is light that appears at a point-symmetrical position with respect to the desired light L_{B} with the 0th-order light L₀ as the center. The ghost image G_{A} and the ghost image G_{B} are unnecessary light components (unnecessary light). Note that, although not illustrated in FIG. 2, the modulated light 102 includes second-order or higher diffracted light (high-order light). High-order light is also unnecessary light. The high-order light is emitted to the dead region Z_{D} outside the region illustrated in FIG. 2.

In FIG. 2, the reflecting surface 162 of the second mirror 16 is irradiated with the desired light L_{A}. The desired light L_{A} emitted to the reflecting surface 162 is projected at a projection angle corresponding to the curvature of the reflecting surface 162. The desired light L_{B} is emitted to the reflecting surface 150 of the first mirror 15. The desired light L_{B} emitted to the reflecting surface 150 is projected at a projection angle corresponding to the curvature of the reflecting surface 150. The 0th-order light L₀ is emitted to the dead region Z_{D} near the boundary between the reflecting surface 161 and the reflecting surface 162. The dead region Z_{D} is irradiated with the ghost image G_{A} of the desired light L_{A} and the ghost image G_{B} of the desired light L_{B}.

The ghost image G of the desired light L appears at a point-symmetrical position of the desired light L with the 0th-order light L₀ as the center. The first mirror 15 and the second mirror 16 are arranged while avoiding a region where the ghost image G is displayed. With such an arrangement, the 0th-order light L₀, the ghost image G_{A}, and the ghost image G_{B} are not emitted to the reflecting surface 150, the reflecting surface 161, and the reflecting surface 162. In addition, the high-order light included in the modulated light 102 is emitted to the dead region Z_{D} deviated from the region illustrated in FIG. 2. Therefore, the 0th-order light L₀, the ghost image G_{A}, the ghost image G_{B}, and the high-order light are not projected to the outside.

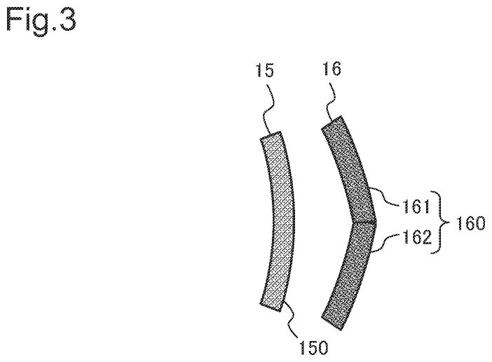

FIG. 3 is a conceptual diagram illustrating a positional relationship between the first mirror 15 and the second mirror 16. FIG. 3 is a cross-sectional view of the first mirror 15 and the second mirror 16 as viewed from above. In the plane of drawing of FIG. 3, the reflecting surface 150 of the first mirror 15 is directed rightward. The second mirror 16 has a shape bent at the center. The reflecting surface 161 of the second mirror 16 is directed to the upper right. The reflecting surface 162 of the second mirror 16 is directed to the lower right. FIG. 3 illustrates an example in which the second mirror 16 is disposed in front of the first mirror 15. The second mirror 16 may be disposed behind the first mirror 15.

The first mirror 15 is a curved mirror having a curved reflecting surface 150. The convex surface of the first mirror 15 is the reflecting surface 150. The reflecting surface 150 has a curvature (first curvature) corresponding to the projection angle of the projection light 105 in the horizontal plane. The projection light 105 spreads in a fan shape in accordance with the curvature (first curvature) of the reflecting surface 150 in the horizontal plane. The reflecting surface 150 has a curvature (second curvature) corresponding to a projection angle of the projection light 105 in the vertical plane. The projection light 105 spreads in accordance with the curvature (second curvature) of the reflecting surface 150 in the vertical plane. The projection light 105 is projected in a rectangular band shape in a vertical plane.

The first mirror 15 is disposed with the reflecting surface 150 facing the modulation part 120 of the spatial light modulator 12. The first mirror 15 is disposed on an optical path (first optical path) of the modulated light 102 modulated by the modulation part 120. The first mirror 15 is disposed while avoiding a position irradiated with an unnecessary light component (unnecessary light) included in the modulated light 102. The reflecting surface 150 is irradiated with light to be projected (desired light) in the modulated light 102. The modulated light 102 emitted to the reflecting surface 150 is reflected by the reflecting surface 150. The desired light reflected by the reflecting surface 150 is projected as the projection light 105. The projection light 105 is enlarged at an enlargement ratio corresponding to the curvature of the reflecting surface 150.

The second mirror 16 is a curved mirror having a curved reflecting surface 160. The convex surface of the second mirror 16 is a reflecting surface. The curvature of the reflecting surface 160 is similar to the curvature of the reflecting surface 150 of the first mirror 15. The second mirror 16 has a shape bent at the center. The reflecting surface 160 of the second mirror 16 is divided into a reflecting surface 161 and a reflecting surface 162 with the bent portion as a boundary.

The second mirror 16 is disposed with the reflecting surface 160 facing the modulation part 120 of the spatial light modulator 12. The second mirror 16 is disposed on the optical path (second optical path) of the modulated light 102 modulated by the modulation part 120. The second mirror 16 is disposed while avoiding a position irradiated with unnecessary light included in the modulated light 102. The reflecting surface 160 is irradiated with desired light of the modulated light 102. The modulated light 102 emitted to the reflecting surface 160 is reflected by the reflecting surface 160. The desired light reflected by the reflecting surface 160 is projected as the projection light 106. The projection light 106 is enlarged at an enlargement ratio corresponding to the curvature of the reflecting surface 160.

The curvatures of the reflecting surface 150 and the reflecting surface 160 (the reflecting surface 161, the reflecting surface 162) may be the same or different. For example, the curvature of the reflecting surface 150 may be smaller than the curvature of the reflecting surface 160. For example, the curvature of the reflecting surface 150 may be larger than the curvature of the reflecting surface 160.

The shapes of the reflecting surface 150 and the reflecting surface 160 (the reflecting surface 161, the reflecting surface 162) are not limited as long as they include a curved portion. For example, the reflecting surface 150 and the reflecting surface 160 have the shape of a side surface of a cylinder. For example, the reflecting surface 150 and the reflecting surface 160 may be a free-form surface or a spherical surface. For example, the reflecting surface 150 and the reflecting surface 160 may have a shape obtained by combining a plurality of curved surfaces. For example, the reflecting surface 150 and the reflecting surface 160 may have a shape obtained by combining a curved surface and a flat surface.

The projection lights 105 to 106 are transmitted as a spatial light signal through a slit (not illustrated) opened in a housing of the transmission device 10. The projection lights 105 to 106 spread as they go away from the transmission device 10. For example, a lens (not illustrated) may be disposed at a subsequent stage of the first mirror 15 and the second mirror 16. The lens is arranged to limit the spread of the projection lights 105 to 106 or to enlarge the spread of the projection lights 105 to 106. The structure and shape of the lens may be determined according to the application.

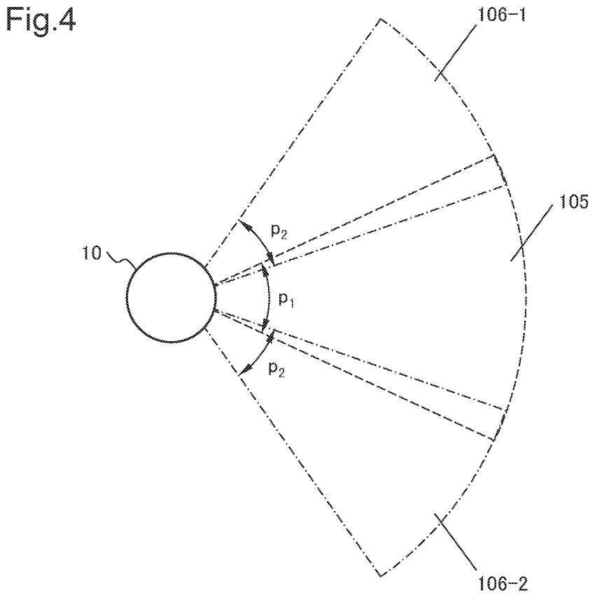

FIG. 4 is a conceptual diagram for explaining spread of the projection light (spatial light signal) transmitted from the transmission device 10. FIG. 4 is a diagram of the transmission device 10 as viewed from above. In the example of FIG. 4, the shape of the transmission device 10 is circular when viewed from above. FIG. 4 illustrates an example of spread of the projection light in the plane of paper. The projection light also spreads in a direction perpendicular to the paper surface.

In FIG. 4, a projection range of the projection light 105 (broken line) reflected by the reflecting surface 150 of the first mirror 15 is a range of a first projection angle p₁. A projection range of the projection light 106-1 (one-dot chain line) reflected by the reflecting surface 161 of the second mirror 16 is a range of a second projection angle p₂. A projection range of the projection light 106-2 (one-dot chain line) reflected by the reflecting surface 162 of the second mirror 16 is a range of the second projection angle p₂. There is an overlapping region between the projection range of the projection light 105 and the projection ranges of the projection lights 106-1 and 106-2 so that no break is generated between projection lights 106-1 and 106-2.

The control unit 18 controls the light source 11 and the spatial light modulator 12. For example, the control unit 18 is achieved by a microcomputer including a processor and a memory. The control unit 18 sets a phase image corresponding to the projected image in the modulation part 120 in accordance with the aspect ratio of tiling set in the modulation part 120 of the spatial light modulator 12. The control unit 18 sets a phase image corresponding to the projected image in the modulation region set in the modulation part 120 of the spatial light modulator 12. For example, the control unit 18 sets, in the modulation part 120, a phase image corresponding to an image according to a use such as image display, communication, or distance measurement. The phase image of the projected image may be stored in advance in a storage unit (not illustrated). The shape and size of the image to be projected are not particularly limited. The control unit 18 controls the spatial light modulator 12 such that a parameter that determines a difference between a phase of the illumination light 101 emitted to the modulation part 120 and a phase of the modulated light 102 reflected by the modulation part 120 changes. For example, the parameter is a value related to optical characteristics such as a refractive index and an optical path length. For example, the control unit 18 controls the pattern (phase image) of the modulation part 120 by changing the voltage applied to the modulation part 120 of the spatial light modulator 12. The phase distribution of the illumination light 101 with which the modulation part 120 of the phase modulation-type spatial light modulator 12 is irradiated is modulated according to the pattern (phase image) of the modulation part 120. Note that the method of driving the spatial light modulator 12 by the control unit 18 is determined according to the modulation scheme of the spatial light modulator 12.

The control unit 18 drives the light source 11 in a state where the phase image corresponding to the image to be displayed is set in the modulation part 120. As a result, the illumination light 101 emitted from the light source 11 is emitted to the modulation part 120 of the spatial light modulator 12 in accordance with the timing at which the phase image is set in the modulation part 120 of the spatial light modulator 12. The illumination light 101 emitted to the modulation part 120 of the spatial light modulator 12 is modulated by the modulation part 120 of the spatial light modulator 12. The modulated light 102 modulated by the modulation part 120 of the spatial light modulator 12 is emitted toward the first mirror 15 and the second mirror 16.

Furthermore, the control unit 18 modulates the illumination light 101 emitted from the light source 11 for communication with a communication target (not illustrated). In communication, the control unit 18 controls the timing at which the illumination light 101 is emitted from the light source 11 in a state where the phase image for communication is set in the modulation part 120 of the spatial light modulator 12. By such control, the illumination light 101 is modulated. The modulation pattern of the illumination light 101 in the communication is arbitrarily set. For example, a configuration for communication (communication unit) may be added separately from the control unit 18. In that case, the control unit 18 may be configured to control the light source 11 and the spatial light modulator 12 according to the condition set by the communication unit.

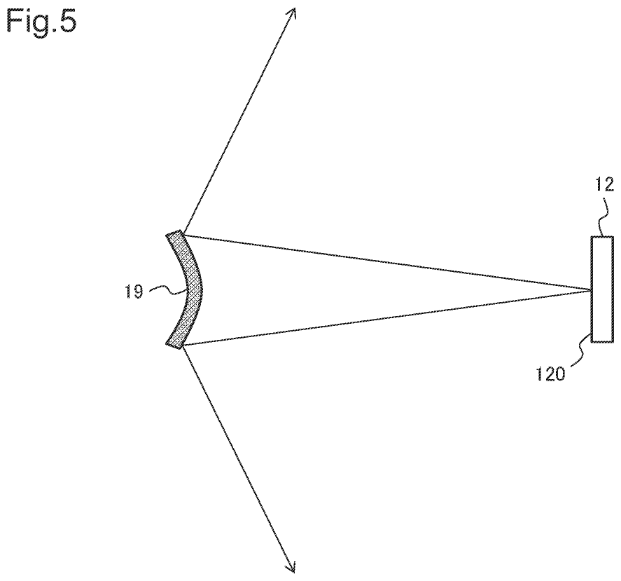

FIG. 5 is a conceptual diagram for describing spread of the projection light in a transmission device according to a comparative example. The transmission device of the comparative example includes only one curved mirror 19 having a curvature radius of R instead of the first mirror 15 and the second mirror included in the transmission device of the present example embodiment. The modulated light (projection light) modulated by the modulation part 120 of spatial light modulator 12 spreads according to curvature radius R of the reflecting surface of curved mirror 19.

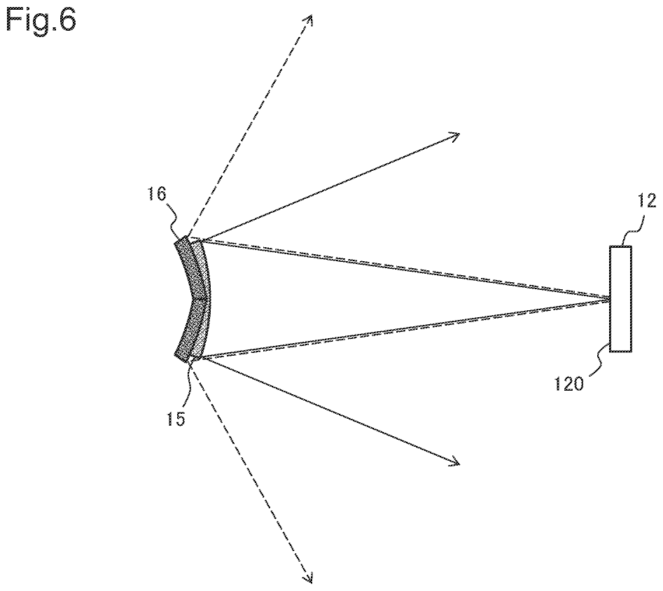

FIG. 6 is a conceptual diagram for explaining spread of the projection light in the transmission device 10 according to the present example embodiment. The transmission device 10 of the present example embodiment includes a first mirror 15 and a second mirror. The radius of curvature of the reflecting surfaces of the first mirror 15 and the second mirror is 2R. The modulated light (projection light) modulated by the modulation part 120 of the spatial light modulator 12 spreads according to the curvature radius 2R of the reflecting surfaces of the first mirror 15 and the second mirror.

In Comparative Example 1 (FIG. 5), a projection range equivalent to the projection light by the transmission device 10 of the present example embodiment is achieved by a single curved mirror 19. Therefore, in Comparative Example 1 (FIG. 5), the radius of curvature of the reflecting surface of curved mirror 19 is set to half the radius of curvature of the reflecting surfaces of the first mirror 15 and the second mirror of the present example embodiment. The smaller the radius of curvature of the reflecting surface, the wider the projection range. However, the smaller the radius of curvature of the reflecting surface is, the larger the magnification factor of the projection light becomes, so that the power density decreases and the reach distance of the projection light becomes shorter. In addition, the reflecting surface having a smaller radius of curvature has larger fluctuation in the projection direction of the projection light according to the positional deviation.

In the present example embodiment (FIG. 6), the reflecting surface 160 (161, 162) of the second mirror 16 is inclined toward the peripheral direction with respect to the reflecting surface 150 of the first mirror 15. According to the present example embodiment, by combining mirrors having a large radius of curvature, a wide projection angle can be obtained as a whole even if the projection angle of each mirror is small. As a result, according to the present example embodiment, since the spread of the projection light is suppressed, the projection light having a long reach distance can be projected. That is, according to the present example embodiment, it is possible to extend the effective communication distance of the spatial light signal while securing a sufficient projection range.

As described above, the transmission device according to the present example embodiment includes the light source, the spatial light modulator, the first mirror, the second mirror, and the control unit. The light source emits illumination light. The spatial light modulator includes a modulation part that modulates the illumination light emitted from the light source. The reflecting surface of the first mirror is a convex curved surface. The first mirror is disposed on the first optical path of the modulated light modulated by the modulation part. The first mirror is disposed at a position deviated from an optical path of unnecessary light included in the modulated light. The first mirror reflects the modulated light toward the first projection range. The modulated light reflected by the first mirror is projected as the projection light within the first projection range. The reflecting surface of the second mirror is a convex curved surface. The second mirror is divided into two reflecting surfaces with the bent portion as a boundary. The second mirror is disposed on the second optical path of the modulated light modulated by the modulation part. The second mirror is disposed at a position deviated from an optical path of unnecessary light included in the modulated light. The two reflecting surfaces of the second mirror are inclined with respect to the reflecting surface of the first mirror from the front center toward the periphery. The second mirror reflects the modulated light toward the second projection range around the first projection range. The modulated light reflected by the second mirror is projected as the projection light within the second projection range. The control unit sets a phase image used for spatial light communication in a modulation part of the spatial light modulator. The control unit controls the light source so that the modulation part is irradiated with light.

In the present example embodiment, two curved mirrors having a lower curvature than a single curved mirror are combined. With such a configuration, according to the present example embodiment, the diffusion angle of the projection light becomes small as compared with a case where a single curved mirror is used.

Therefore, according to the present example embodiment, the spread of the projection light is suppressed, and the reach distance of the projection light is extended. For example, according to the present example embodiment, when a curved mirror having a curvature that is half that of a single curved mirror is used, the reach distance of the projection light can be made equal to that of a single curved mirror. That is, according to the present example embodiment, it is possible to extend the effective communication distance of the spatial light signal while securing a sufficient projection range.

Further, according to the present example embodiment, the resolution of the projection light (spatial light signal) can be improved as compared with a single curved mirror. Therefore, according to the present example embodiment, the displacement of the projection angle due to the displacement of the dot displayed by the projection light (spatial light signal) is small, and stable projection can be achieved.

In the present example embodiment, a first mirror in charge of the center projection range and a second mirror in charge of the peripheral projection range are included. The second mirror is bent at a center portion toward a peripheral projection range. Since the reflecting surfaces of the first mirror and the second mirror also have curvature in the vertical direction, interference between the plurality of reflecting surfaces can be prevented.

### Second Example Embodiment

Next, a transmission device according to a second example embodiment will be described with reference to the drawings. The transmission device of the present example embodiment includes a third mirror in addition to the first mirror and the second mirror. In this respect, the present example embodiment is different from the first example embodiment.

### Configuration

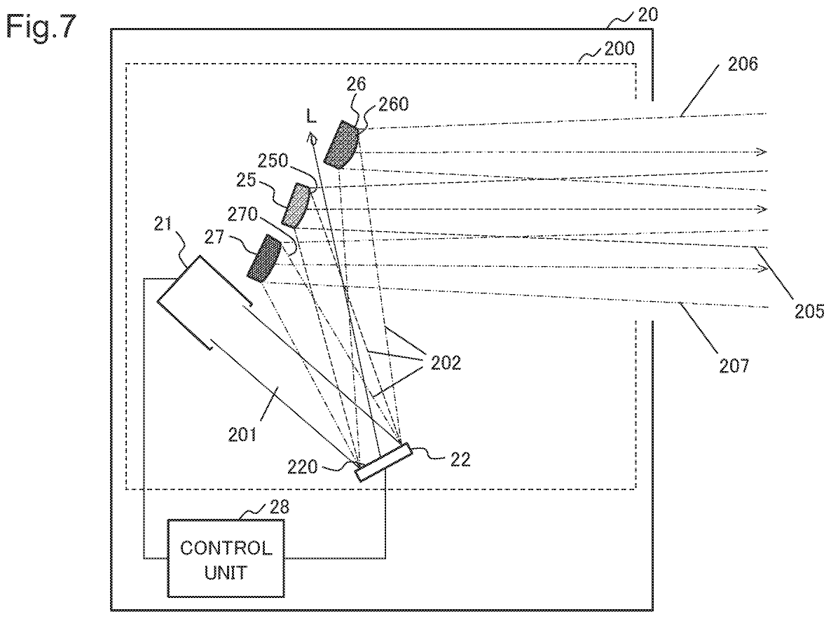

FIG. 7 is a conceptual diagram illustrating an example of a configuration of a transmission device 20 according to the present example embodiment. The transmission device 20 includes a light source 21, a spatial light modulator 22, a first mirror 25, a second mirror 26, a third mirror 27, and a control unit 28. The light source 21, the spatial light modulator 22, the first mirror 25, the second mirror 26, and the third mirror 27 constitute a transmitter 200. FIG. 7 is a conceptual diagram of the internal configuration of the transmission device 20 as viewed from the lateral direction. FIG. 7 is conceptual, and does not accurately represent a shape of each component, a positional relationship between components, traveling of light, and the like.

The light source 21 has the same configuration as the light source 11 of the first example embodiment. The light source 21 emits illumination light 201 under the control of the control unit 28. The light source 21 includes a light emitter and an optical system associated with the light emitter. The emission surface of the light source 21 is directed to the spatial light modulator 22. The light source 21 emits laser light (illumination light 201) in a predetermined wavelength band toward the spatial light modulator 22 under the control of the control unit 28.

The spatial light modulator 22 has the same configuration as the spatial light modulator 12 of the first example embodiment. The spatial light modulator 22 is a two-dimensional phase modulator. The spatial light modulator 22 includes a modulation part 220. At least one modulation region is set in the modulation part 220. In the example of FIG. 7, the first mirror 25, the second mirror 26, and the third mirror 27 are arranged at a subsequent stage of the spatial light modulator 22. A common modulation region may be set for all the reflecting surfaces of the first mirror 25, the second mirror 26, and the third mirror 27, or different modulation regions may be allocated. Modulation unit 220 in which the modulation region is set is irradiated with the illumination light 201 emitted from the light source.

In the modulation region set in the modulation part 220, a pattern (phase image) corresponding to the image displayed by projection lights 205 to 207 is set according to the control of the control unit 28. The illumination light 201 incident on the modulation region set in the modulation part 220 is modulated according to the pattern (phase image) set in the modulation region. The modulated light 202 modulated in the modulation region travels toward the first mirror 25, the second mirror 26, and the third mirror 27 disposed at a subsequent stage.

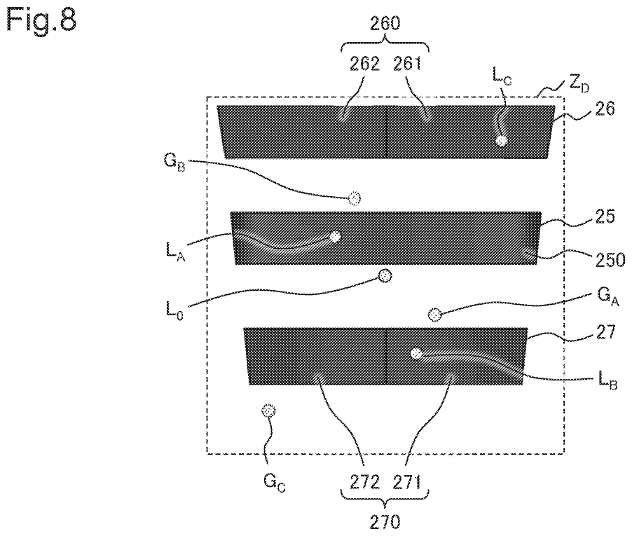

FIG. 8 is a conceptual diagram illustrating a positional relationship among the first mirror 25, the second mirror 26, and the third mirror 27. FIG. 8 is a conceptual diagram of the first mirror 25, the second mirror 26, and the third mirror 27 as viewed from the reflecting surface side. The first mirror 25 has a reflecting surface 250. The second mirror 26 has a reflecting surface 260. The reflecting surface 260 is divided into a reflecting surface 261 and a reflecting surface 262. The third mirror 27 has a reflecting surface 270. The reflecting surface 270 is divided into a reflecting surface 271 and a reflecting surface 272.

FIG. 8 illustrates a region (dead region Z_{D}) where the modulated light 202 is not reflected around the first mirror 25, the second mirror 26, and the third mirror 27. With respect to the region around the first mirror 25, the second mirror 26, and the third mirror 27, a region not illustrated as the dead region Z_{D} is also included in the dead region Z_{D}.

FIG. 8 illustrates an example of positions irradiated with the 0th-order light L₀, the desired light L_{A}, the desired light L_{B}, the desired light L_{C}, the ghost image G_{A}, the ghost image G_{B}, and the ghost image G_{C}. The 0th-order light L₀ is 0th-order diffracted light included in the modulated light 202. The desired light L_{A}, the desired light L_{B}, and the desired light L_{C} are first-order diffracted light included in the modulated light 202. The desired light L_{A}, the desired light L_{B}, and the desired light L_{C} are light to be projected. The ghost image G_{A} is light that appears at a point-symmetrical position with respect to the desired light L_{A} with the 0th-order light L₀ as the center. The ghost image G_{B} is light that appears at a point-symmetrical position with respect to the desired light L_{B} with the 0th-order light L₀ as the center. The ghost image G_{C} is light that appears at a point-symmetrical position with respect to the desired light L_{C} with the 0th-order light L₀ as the center. The ghost image G_{A}, the ghost image G_{B}, and the ghost image G_{C} are unnecessary light components. Although not illustrated in FIG. 8, the modulated light 202 includes second-order or higher diffracted light (high-order light).

In FIG. 8, the desired light L_{A} is emitted to the reflecting surface 250 of the first mirror 25. The desired light L_{A} emitted to the reflecting surface 250 is projected at a projection angle corresponding to the curvature of the reflecting surface 250. The reflecting surface 271 of the third mirror 27 is irradiated with the desired light L_{B}. The desired light L_{B} emitted to the reflecting surface 271 is projected at a projection angle corresponding to the curvature of the reflecting surface 271. The reflecting surface 261 of the second mirror 26 is irradiated with the desired light L_{C}. The desired light L_{C} emitted to the reflecting surface 261 is projected at a projection angle corresponding to the curvature of the reflecting surface 261. The 0th-order light L₀ is emitted to the dead region Z_{D} near the first mirror 25. The dead region Z_{D} is irradiated with the ghost image G_{A} of the desired light L_{A}, the ghost image G_{B} of the desired light L_{B}, and the ghost image G_{C} of the desired light L_{C}.

The ghost image G of the desired light L appears at a point-symmetrical position of the desired light L with the 0th-order light L₀ as the center. The first mirror 25, the second mirror 26, and the third mirror are arranged while avoiding a region where the ghost image G is displayed. With such an arrangement, the 0th-order light L₀, the ghost image G_{A}, the ghost image G_{B}, and the ghost image G_{C} are not emitted to the reflecting surface 250, the reflecting surface 261, the reflecting surface 262, the reflecting surface 271, and the reflecting surface 272. In addition, the high-order light included in the modulated light 202 is emitted to the dead region outside the region illustrated in FIG. 8. Therefore, the 0th-order light L₀, the ghost image G_{A}, the ghost image G_{B}, the ghost image G_{C}, and the high-order light are not projected to the outside.

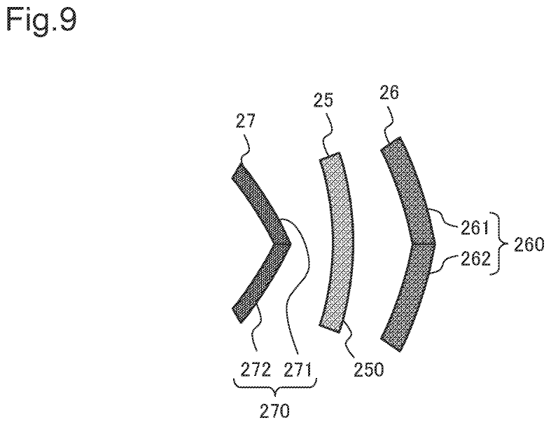

FIG. 9 is a conceptual diagram illustrating a positional relationship among the first mirror 25, the second mirror 26, and the third mirror 27. FIG. 9 is a cross-sectional view of the first mirror 25, the second mirror 26, and the third mirror 27 as viewed from above. In the plane of drawing of FIG. 9, the reflecting surface 250 of the first mirror 25 is directed rightward. The second mirror 26 and the third mirror 27 have a shape bent at the center. The reflecting surface 261 of the second mirror 26 and the reflecting surface 271 of the third mirror 27 are directed to the upper right. The reflecting surface 271 is more inclined with respect to the reflecting surface 250 of the first mirror 25 than the reflecting surface 261. The reflecting surface 262 of the second mirror 26 and the reflecting surface 272 of the third mirror 27 are directed to the lower right. The reflecting surface 272 is more inclined with respect to the reflecting surface 250 of the first mirror 25 than the reflecting surface 262. FIG. 9 illustrates an example in which the second mirror 26 is disposed in front of the first mirror 25 and the third mirror 27 is disposed behind the first mirror 25. The order in which the first mirror 25, the second mirror 26, and the third mirror 27 are disposed can be arbitrarily set. For example, the second mirror 26 may be disposed behind the first mirror 25, and the third mirror 27 may be disposed in front of the first mirror 25.

The first mirror 25 has the same configuration as the first mirror 15 of the first example embodiment. The first mirror 25 is a curved mirror having a curved reflecting surface 250. The convex surface of the first mirror 25 is the reflecting surface 250. The reflecting surface 250 has a curvature corresponding to a projection angle of the projection light 205.

The first mirror 25 is disposed with the reflecting surface 250 facing the modulation part 220 of the spatial light modulator 22. The first mirror 25 is disposed on an optical path (first optical path) of the modulated light 202 modulated by the modulation part 220. The first mirror 25 is disposed while avoiding a position irradiated with an unnecessary light component (unnecessary light) included in the modulated light 202. The reflecting surface 250 is irradiated with light to be projected (desired light) in the modulated light 202. The modulated light 202 emitted to the reflecting surface 250 is reflected by the reflecting surface 250. The desired light reflected by the reflecting surface 250 is projected as the projection light 205. The projection light 205 is enlarged at an enlargement ratio corresponding to the curvature of the reflecting surface 250.

The second mirror 26 has the same configuration as the second mirror 16 of the first example embodiment. The second mirror 26 is a curved mirror having a curved reflecting surface 260. The convex surface of the second mirror 26 is the reflecting surface 260. The reflecting surface 260 has a curvature corresponding to a projection angle of the projection light 206. The curvature of the reflecting surface 260 may be the same as or different from the curvature of the reflecting surface 250 of the first mirror 25. The second mirror 26 has a shape bent at the center. The reflecting surface 260 of the second mirror 26 is divided into a reflecting surface 261 and a reflecting surface 262 with the bent portion as a boundary.

The second mirror 26 is disposed with the reflecting surface 260 facing the modulation part 220 of the spatial light modulator 22. The second mirror 26 is disposed on the optical path (second optical path) of the modulated light 202 modulated by the modulation part 220. The second mirror 26 is disposed while avoiding a position irradiated with unnecessary light included in the modulated light 202. The reflecting surface 260 is irradiated with desired light of the modulated light 202. The modulated light 202 emitted to the reflecting surface 260 is reflected by the reflecting surface 260. The desired light reflected by the reflecting surface 260 is projected as the projection light 206. The projection light 206 is enlarged at an enlargement ratio corresponding to the curvature of the reflecting surface 260.

The third mirror 27 is a curved mirror having a curved reflecting surface 270. The convex surface of the third mirror 27 is the reflecting surface 270. The reflecting surface 270 has a curvature corresponding to a projection angle of the projection light 207. The curvature of the reflecting surface 270 may be the same as or different from the curvature of the reflecting surface 250 of the first mirror 25, the reflecting surface 261 of the second mirror 26, and the reflecting surface 262 of the second mirror 26. The third mirror 27 has a shape bent at the center. The reflecting surface 270 of the third mirror 27 is divided into the reflecting surface 271 and the reflecting surface 272 with a bent portion as a boundary.

The third mirror 27 is disposed with the reflecting surface 270 facing the modulation part 220 of the spatial light modulator 22. The third mirror 27 is disposed on the third optical path of the modulated light 202 modulated by the modulation part 220. The third mirror 27 is disposed while avoiding a position irradiated with unnecessary light included in the modulated light 202. The reflecting surface 270 is irradiated with desired light of the modulated light 202. The modulated light 202 emitted to the reflecting surface 270 is reflected by the reflecting surface 270. The desired light reflected by the reflecting surface 270 is projected as the projection light 207. The projection light 207 is enlarged at an enlargement ratio corresponding to the curvature of the reflecting surface 270.

The projection lights 205 to 207 are transmitted as a spatial light signal through a slit (not illustrated) opened in a housing of the transmission device 20. The projection lights 205 to 207 spread as they go away from the transmission device 20. For example, a lens (not illustrated) may be disposed at a subsequent stage of the first mirror 25, the second mirror 26, and the third mirror 27. The lens is arranged to limit the spread of the projection lights 205 to 207 or to enlarge the spread of the projection lights 205 to 207. The structure and shape of the lens may be determined according to the application.

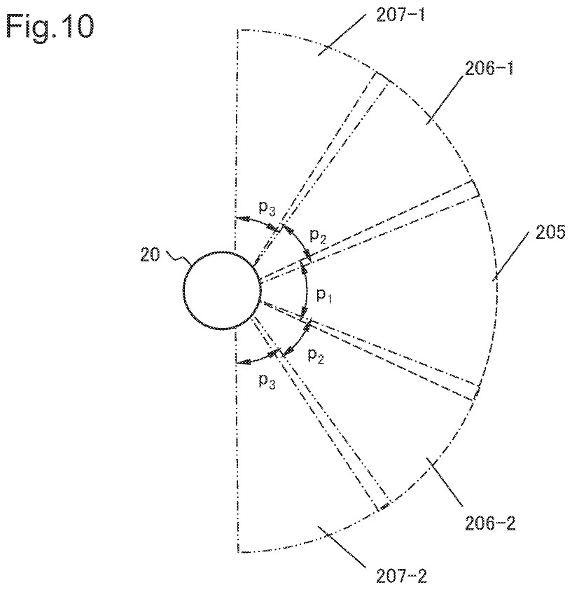

FIG. 10 is a conceptual diagram for explaining spread of the projection light (spatial light signal) transmitted from the transmission device 20. FIG. 10 is a diagram of the transmission device 20 as viewed from above. In the example of FIG. 10, the shape of the transmission device 20 is circular when viewed from above. FIG. 10 illustrates an example of the spread of the projection light in the plane of paper. The projection light also spreads in a direction perpendicular to the paper surface.

In FIG. 10, a projection range of the projection light 205 (broken line) reflected by the reflecting surface 250 of the first mirror 25 is a range of the first projection angle p₁. A projection range of the projection light 206-1 (one-dot chain line) reflected by the reflecting surface 261 of the second mirror 26 is a range of the second projection angle p₂. A projection range of the projection light 206-2 (one-dot chain line) reflected by the reflecting surface 262 of the second mirror 26 is a range of the second projection angle p₂. A projection range of the projection light 207-1 (two-dot chain line) reflected by the reflecting surface 270 of the third mirror 27 is a range of a third projection angle p₃. A projection range of the projection light 207-2 (two-dot chain line) reflected by the reflecting surface 272 of the third mirror 27 is a range of the third projection angle p₃. A boundary portion of a projection range of the projection light 205, the projection lights 206-1 and 206-2, and the projection lights 207-1 and 207-2 has an overlapping region in order not to generate a break.

The control unit 28 has the same configuration as the control unit 18 of the first example embodiment. The control unit 28 controls the light source 21 and the spatial light modulator 22. For example, the control unit 28 is achieved by a microcomputer including a processor and a memory. The control unit 28 sets a phase image corresponding to the projected image in the modulation part 220 in accordance with the aspect ratio of tiling set in the modulation part 220 of the spatial light modulator 22. The control unit 28 sets a phase image corresponding to the projected image in the modulation region set in the modulation part 220 of the spatial light modulator 22.

The control unit 28 drives the light source 21 in a state where the phase image corresponding to the image to be displayed is set in the modulation part 220. As a result, the illumination light 201 emitted from the light source 21 is emitted to the modulation part 220 of the spatial light modulator 22 in accordance with the timing at which the phase image is set in the modulation part 220 of the spatial light modulator 22. The illumination light 201 emitted to the modulation part 220 of the spatial light modulator 22 is modulated by the modulation part 220 of the spatial light modulator 22. The modulated light 202 modulated by the modulation part 220 is emitted toward the first mirror 25, the second mirror 26, and the third mirror 27.

Furthermore, the control unit 28 modulates the illumination light 201 emitted from the light source 21 for communication with a communication target (not illustrated). In communication, the control unit 28 controls the timing at which the illumination light 201 is emitted from the light source 21 in a state where the phase image for communication is set in the modulation part 220 of the spatial light modulator 22. By such control, the illumination light 201 is modulated. The modulation pattern of the illumination light 201 in the communication is arbitrarily set. For example, a configuration for communication (communication unit) may be added separately from the control unit 28. In that case, the control unit 28 may be configured to control the light source 21 and the spatial light modulator 22 according to the condition set by the communication unit.

In order to realize the projection range of the projection light by the transmitter having the configuration of the present example embodiment by a single curved mirror, a curved mirror having a reflecting surface with a large curvature is required. The projection range becomes wider as the curvature of the reflecting surface is larger. However, since the energy of the projection light at the same distance becomes smaller as the reflecting surface has a larger curvature, the reach distance of the projection light becomes shorter. In addition, the larger the curvature of the reflecting surface, the greater the variation in the projection direction of the projection light according to the positional deviation.

In the present example embodiment, the reflecting surface 261 and the reflecting surface 262 of the second mirror 26, and the reflecting surface 271 and the reflecting surface 272 of the third mirror 27 are inclined with respect to the reflecting surface 250 of the first mirror 25. Therefore, according to the present example embodiment, by combining mirrors having a small curvature, it is possible to realize a wide projection angle as a whole although the projection angle of each mirror is small. As a result, according to the present example embodiment, the projection light having a long reach distance can be projected in a wider range. That is, according to the present example embodiment, it is possible to extend the effective communication distance of the spatial light signal while securing a sufficient projection range.

As described above, the transmission device according to the present example embodiment includes a light source, a spatial light modulator, a first mirror, a second mirror, a third mirror, and a control unit. The light source emits illumination light. The spatial light modulator includes a modulation part that modulates the illumination light emitted from the light source. The reflecting surface of the first mirror is a convex curved surface. The first mirror is disposed on the first optical path of the modulated light modulated by the modulation part. The first mirror reflects the modulated light toward the first projection range. The modulated light reflected by the first mirror is projected as the projection light within the first projection range. The reflecting surface of the second mirror is a convex curved surface. The second mirror is divided into two reflecting surfaces with the bent portion as a boundary. The two reflecting surfaces of the second mirror are inclined with respect to the reflecting surface of the first mirror from the front center toward the periphery. The second mirror is disposed on the second optical path of the modulated light modulated by the modulation part. The second mirror reflects the modulated light toward the inside of the second projection range around the first projection range. The modulated light reflected by the second mirror is projected as the projection light in the second projection range. The reflecting surface of the third mirror is a convex curved surface. The third mirror is divided into two reflecting surfaces with the bent portion as a boundary. The two reflecting surfaces of the third mirror are inclined with respect to the reflecting surface of the first mirror from the front center toward the periphery more than the reflecting surface of the second mirror. The third mirror is disposed on the third optical path of the modulated light modulated by the modulation part. The third mirror reflects the modulated light toward a third projection range around the second projection range. The modulated light reflected by the third mirror is projected as the projection light within the third projection range. The control unit sets a phase image used for spatial light communication in a modulation part of the spatial light modulator. The control unit controls the light source so that the modulation part is irradiated with light.

The first mirror, the second mirror, and the third mirror are disposed at positions deviated from an optical path of unnecessary light included in the modulated light. For example, the first mirror, the second mirror, and the third mirror are disposed while avoiding positions irradiated with a ghost image of desired light included in unnecessary light. For example, the first mirror, the second mirror, and the third mirror are disposed while avoiding positions irradiated with the 0th-order light included in unnecessary light.

In the present example embodiment, three curved mirrors having a lower curvature than a single curved mirror are combined. With such a configuration, according to the present example embodiment, the diffusion angle of the projection light is further reduced as compared with the case where the two curved mirrors are combined. Therefore, according to the present example embodiment, the spread of the projection light is suppressed as compared with the first example embodiment, and the reach distance of the projection light is further extended. For example, according to the present example embodiment, when a curved mirror having a curvature of about ⅓ of that of a single curved mirror is used, the reach distance of the projection light can be made equal to that of a single curved mirror. That is, according to the present example embodiment, it is possible to extend the effective communication distance of the spatial light signal while securing a sufficient projection range. Furthermore, according to the present example embodiment, the projection range can be expanded while an effective communication distance of the spatial light signal is secured.

### Third Example Embodiment

Next, a transmission device according to a third example embodiment will be described with reference to the drawings. The first mirror of the transmission device according to the present example embodiment has a flat reflecting surface. In this respect, the present example embodiment is different from the first example embodiment. The first mirror of the transmission device of the second example embodiment may be replaced with the first mirror of the present example embodiment.

### Configuration

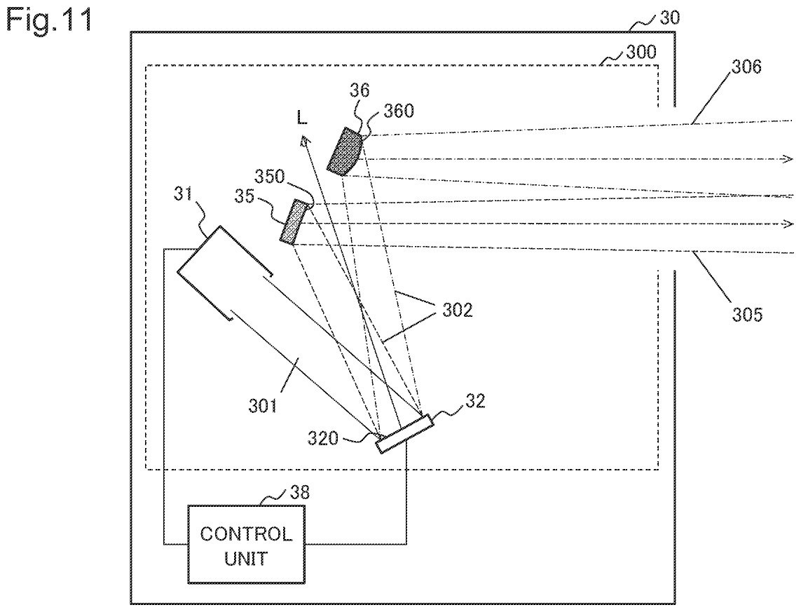

FIG. 11 is a conceptual diagram illustrating an example of a configuration of a transmission device 30 according to the present example embodiment. The transmission device 30 includes a light source 31, a spatial light modulator 32, a first mirror 35, a second mirror 36, and a control unit 38. The light source 31, the spatial light modulator 32, the first mirror 35, and the second mirror 36 constitute a transmitter 300. FIG. 11 is a conceptual diagram of the internal configuration of the transmission device 30 as viewed from the lateral direction. FIG. 11 is conceptual, and does not accurately represent the shape of each component, the positional relationship between components, the travel of light, and the like.

The light source 31 has the same configuration as the light source 11 of the first example embodiment. The light source 31 emits illumination light 301 under the control of the control unit 38. The light source 31 includes a light emitter and an optical system associated with the light emitter. The emission surface of the light source 31 is directed to the spatial light modulator 32. The light source 31 emits laser light (illumination light 301) in a predetermined wavelength band toward the spatial light modulator 32 under the control of the control unit 38.

The spatial light modulator 32 has the same configuration as the spatial light modulator 12 of the first example embodiment. The spatial light modulator 32 is a two-dimensional phase modulator. The spatial light modulator 32 includes a modulation part 320. At least one modulation region is set in the modulation part 320. In the example of FIG. 11, the first mirror 35 and the second mirror 36 are arranged at a subsequent stage of the spatial light modulator 32. For all the reflecting surfaces of the first mirror 25 and the second mirror 26, a common modulation region may be set, or different modulation regions may be allocated. The modulation part 320 in which the modulation region is set is irradiated with the illumination light 301 emitted from the light source.

In the modulation region set in the modulation part 320, a pattern (phase image) corresponding to the image displayed by projection lights 305 to 306 is set according to the control of the control unit 38. The illumination light 301 incident on the modulation region set in the modulation part 320 is modulated according to the pattern (phase image) set in the modulation region. The modulated light 302 modulated in each modulation region travels toward the first mirror 35 and the second mirror 36 arranged at the subsequent stage.

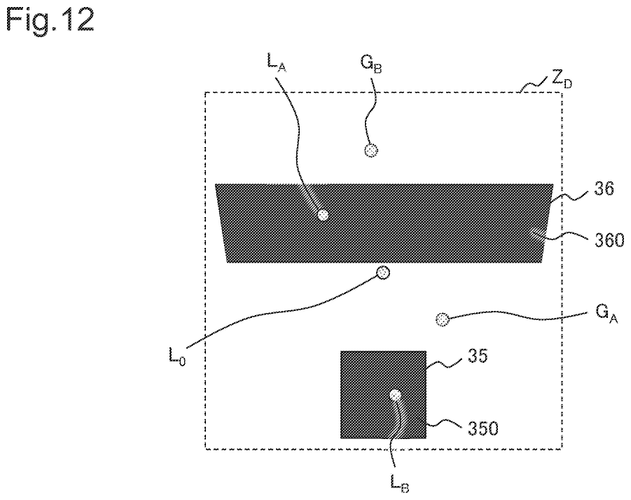

FIG. 12 is a conceptual diagram illustrating a positional relationship between the first mirror 35 and the second mirror 36. FIG. 12 is a conceptual diagram of the first mirror 35 and the second mirror 36 as viewed from the reflecting surface side. FIG. 12 illustrates a region (dead region Z_{D}) where the modulated light 302 is not reflected around the first mirror 35 and the second mirror 36. With respect to the region around the first mirror 35 and the second mirror 36, a region not illustrated as the dead region Z_{D} is also included in the dead region Z_{D}.

FIG. 12 illustrates an example of positions irradiated with the 0th-order light L₀, the desired light L_{A}, the desired light L_{B}, the ghost image G_{A}, and the ghost image G_{B}. The 0th-order light L₀ is 0th-order diffracted light included in the modulated light 302. The desired light L_{A} and the desired light L_{B} are first-order diffracted light included in the modulated light 302. The desired light L_{A} and the desired light L_{B} are light to be projected. The ghost image G_{A} is light that appears at a point-symmetrical position with respect to the desired light L_{A} with the 0th-order light L₀ as the center. The ghost image G_{B} is light that appears at a point-symmetrical position with respect to the desired light L_{B} with the 0th-order light L₀ as the center. The ghost image G_{A} and the ghost image G_{B} are unnecessary light components. Note that, although not illustrated in FIG. 12, the modulated light 302 includes second-order or higher diffracted light (high-order light).

In FIG. 12, the desired light L_{A} is emitted to the reflecting surface 360 of the second mirror 36. The desired light L_{A} emitted to the reflecting surface 360 is projected at a projection angle corresponding to the curvature of the reflecting surface 360. The desired light L_{B} is emitted to the reflecting surface 350 of the first mirror 35. The desired light L_{B} emitted to the reflecting surface 350 is projected at a projection angle corresponding to an incident angle with respect to the reflecting surface 350. The 0th-order light L₀ is emitted to the dead region Z_{D} near the second mirror 36. The dead region Z_{D} is irradiated with the ghost image G_{A} of the desired light L_{A} and the ghost image G_{B} of the desired light L_{B}.

The ghost image G of the desired light L appears at a point-symmetrical position of the desired light L with the 0th-order light L₀ as the center. The first mirror 35 and the second mirror 36 are arranged while avoiding a region where the ghost image G is displayed. With such an arrangement, the 0th-order light L₀, the ghost image G_{A}, and the ghost image G_{B} are not emitted to the reflecting surface 350 and the reflecting surface 360. In addition, the high-order light included in the modulated light 302 is emitted to the dead region Z_{D} deviated from the region illustrated in FIG. 12. Therefore, the 0th-order light L₀, the ghost image G_{A}, the ghost image G_{B}, and the high-order light are not projected to the outside.

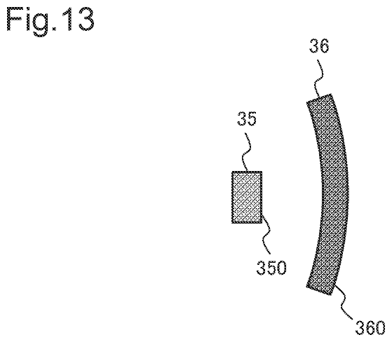

FIG. 13 is a conceptual diagram illustrating a positional relationship between the first mirror 35 and the second mirror 36. FIG. 13 is a cross-sectional view of the first mirror 35 and the second mirror 36 as viewed from above. In the plane of drawing of FIG. 13, the reflecting surface 350 of the first mirror 35 is directed rightward. Similarly, the reflecting surface 360 of the second mirror 36 is directed rightward.

The first mirror 35 is a flat mirror having a flat reflecting surface 350. At least one of the two flat surfaces of the first mirror 35 is the reflecting surface 350. The shape of the reflecting surface 350 is not limited as long as it includes a planar portion. For example, the reflecting surface 350 may have a shape obtained by combining a plurality of flat surfaces. For example, the reflecting surface 350 may have a shape obtained by combining a curved surface and a flat surface.

The first mirror 35 is disposed with the reflecting surface 350 facing the modulation part 320 of the spatial light modulator 32. The first mirror 35 is disposed on an optical path (first optical path) of the modulated light 302 modulated by the modulation part 320. The first mirror 35 is disposed while avoiding a position irradiated with an unnecessary light component (unnecessary light) included in the modulated light 302. The reflecting surface 350 is irradiated with light to be projected (desired light) in the modulated light 302. The modulated light 302 emitted to the reflecting surface 350 is reflected by the reflecting surface 350. The desired light reflected by the reflecting surface 350 is projected as the projection light 305.

The second mirror 36 is a curved mirror having a curved reflecting surface 360. The convex surface of the second mirror 36 is the reflecting surface 360. The reflecting surface 360 has a curvature corresponding to a projection angle of the projection light 306. The shape of the reflecting surface 360 is not limited as long as it includes a curved portion. For example, the reflecting surface 360 has the shape of a side surface of a cylinder. For example, the reflecting surface 360 may be a free-form surface or a spherical surface. For example, the reflecting surface 360 may have a shape obtained by combining a plurality of curved surfaces. For example, the reflecting surface 360 may have a shape obtained by combining a curved surface and a flat surface.

The second mirror 36 is disposed with the reflecting surface 360 facing the modulation part 320 of the spatial light modulator 32. The second mirror 36 is disposed on the optical path (second optical path) of the modulated light 302 modulated by the modulation part 320. The second mirror 36 is disposed while avoiding a position irradiated with an unnecessary light component (unnecessary light) included in the modulated light 302. The reflecting surface 360 is irradiated with light to be projected (desired light) in the modulated light 302. The modulated light 302 emitted to the reflecting surface 360 is reflected by the reflecting surface 360. The desired light reflected by the reflecting surface 360 is enlarged at an enlargement ratio corresponding to the curvature of the reflecting surface 360 and projected as the projection light 306.

The projection light 305 and the projection light 306 are transmitted as a spatial light signal through a slit (not illustrated) opened in a housing of the transmission device 30. The projection light 305 and the projection light 306 spread as they go away from the transmission device 30. For example, a lens (not illustrated) for limiting the spread of the projection light 305 and the projection light 306 or enlarging the spread of the projection light 305 and the projection light 306 may be disposed at the subsequent stage of the first mirror 35 and the second mirror 36.

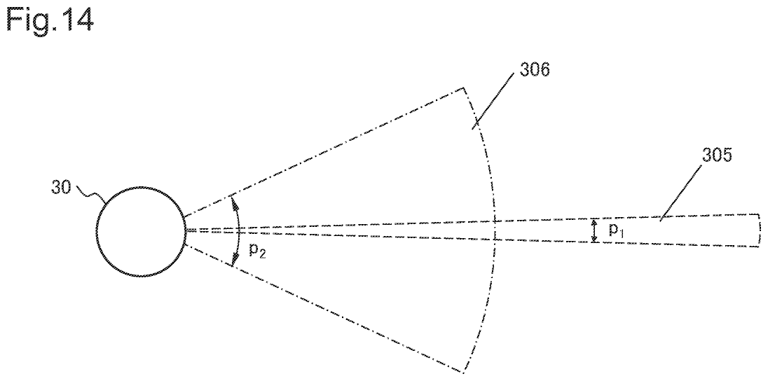

FIG. 14 is a conceptual diagram for explaining spread of the projection light (spatial light signal) transmitted from the transmission device 30. FIG. 14 is a diagram of the transmission device 30 as viewed from above. In the example of FIG. 14, the shape of the transmission device 30 is circular when viewed from above. FIG. 14 illustrates an example of the spread of the projection light in the plane of paper. The projection light also spreads in a direction perpendicular to the paper surface.

In FIG. 14, a projection range of the projection light 305 (broken line) reflected by the reflecting surface 350 of the first mirror 35 is a range of the first projection angle p₁. A projection range of the projection light 306 (one-dot chain line) reflected by the reflecting surface 360 of the second mirror 36 is a range of the second projection angle p₂. There is a region where the projection range of the projection light 305 and the projection range of the projection light 306 overlap.

The control unit 38 has the same configuration as the control unit 18 of the first example embodiment. The control unit 38 controls the light source 31 and the spatial light modulator 32. For example, the control unit 38 is achieved by a microcomputer including a processor and a memory. The control unit 38 sets a phase image corresponding to the projected image in the modulation part 320 in accordance with the aspect ratio of tiling set in the modulation part 320 of the spatial light modulator 32. The control unit 38 sets a phase image corresponding to the projected image in the modulation region set in the modulation part 320 of the spatial light modulator 32. For example, the control unit 38 sets, in the modulation part 320, a phase image corresponding to an image according to a use such as image display, communication, or distance measurement. The phase image of the projected image may be stored in advance in a storage unit (not illustrated). The shape and size of the image to be projected are not particularly limited.

The control unit 38 drives the light source 31 in a state where the phase image corresponding to the image to be displayed is set in the modulation part 320. As a result, the illumination light 301 emitted from the light source 31 is emitted to the modulation part 320 of the spatial light modulator 32 in accordance with the timing at which the phase image is set in the modulation part 320 of the spatial light modulator 32. The illumination light 301 emitted to the modulation part 320 of the spatial light modulator 32 is modulated by the modulation part 320 of the spatial light modulator 32. The modulated light 302 modulated by the modulation part 320 is emitted toward the first mirror 35 and the second mirror 36.

Furthermore, the control unit 38 modulates the illumination light 301 emitted from the light source 31 for communication with a communication target (not illustrated). In communication, the control unit 38 controls the timing at which the illumination light 301 is emitted from the light source 31 in a state where the phase image for communication is set in the modulation part 320 of the spatial light modulator 32. By such control, the illumination light 301 is modulated. The modulation pattern of the illumination light 301 in the communication is arbitrarily set. For example, a configuration for communication (communication unit) may be added separately from the control unit 38. In that case, the control unit 38 may be configured to control the light source 31 and the spatial light modulator 32 according to the condition set by the communication unit.

In the present example embodiment, since the overall projection angle depends on the projection light 306, the overall projection range is not widened. According to the present example embodiment, the projection light 305 having high energy density can be projected in the front direction with respect to the first mirror 35. Therefore, according to the present example embodiment, it is possible to extend the reach distance of the projection light while maintaining a wide projection range in a specific direction.

### Modification Example

Next, a transmission device according to a modification example of the present example embodiment will be described with reference to the drawings. The transmission device of the present modification example includes two flat mirrors. The transmission device of the present modification example is similar to the configuration of FIG. 11 except that a new flat mirror is added. In the present modification example, the arrangement of the flat mirror and the spread of the projection light will be described.

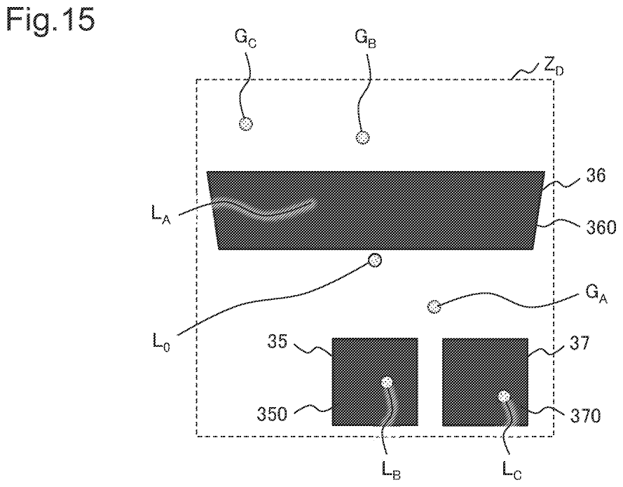

FIG. 15 is a conceptual diagram for describing the mirror arrangement of a transmission device of the present modification example. The transmission device of the present modification example includes three mirrors, that is, a first mirror 35, a second mirror 36, and a third mirror 37. Similarly to the second mirror 36, the third mirror 37 has a flat reflecting surface 370. FIG. 15 is a conceptual diagram illustrating a positional relationship among the first mirror 35, the second mirror 36, and the third mirror 37. FIG. 15 is a conceptual diagram of the first mirror 35, the second mirror 36, and the third mirror 37 as viewed from the reflecting surface side. FIG. 15 illustrates a region (dead region Z_{D}) where the modulated light 302 is not reflected around the first mirror 35, the second mirror 36, and the third mirror 37. With respect to the region around the first mirror 35 and the second mirror 36, a region not illustrated as the dead region Z_{D} is also included in the dead region Z_{D}.

FIG. 15 illustrates an example of positions irradiated with the 0th-order light L_{C}), the desired light L_{A}, the desired light L_{B}, the desired light L_{C}, the ghost image G_{A}, the ghost image G_{B}, and the ghost image G_{C}. The 0th-order light L₀ is 0th-order diffracted light included in the modulated light 302. The desired light L_{A}, the desired light L_{B}, and the desired light L_{C} are first-order diffracted light included in the modulated light 302. The desired light L_{A}, the desired light L_{B}, and the desired light L_{C} are light to be projected. The ghost image G_{A} is light that appears at a point-symmetrical position with respect to the desired light L_{A} with the 0th-order light L₀ as the center. The ghost image G_{B} is light that appears at a point-symmetrical position with respect to the desired light L_{B} with the 0th-order light L₀ as the center. The ghost image G_{C} is light that appears at a point-symmetrical position with respect to the desired light L_{C} with the 0th-order light L₀ as the center. The ghost image G_{A}, the ghost image G_{B}, and the ghost image G_{C} are unnecessary light components. Note that, although not illustrated in FIG. 15, the modulated light 302 includes second-order or higher diffracted light (high-order light).

In FIG. 15, the desired light L A is emitted to the reflecting surface 360 of the second mirror 36. The desired light L_{A} emitted to the reflecting surface 360 is projected at a projection angle corresponding to the curvature of the reflecting surface 360. The desired light L_{B} is emitted to the reflecting surface 350 of the first mirror 35. The desired light L_{B} emitted to the reflecting surface 350 is projected at a projection angle corresponding to an incident angle with respect to the reflecting surface 350. The reflecting surface 370 of the third mirror 37 is irradiated with the desired light L_{C}. The desired light L_{C} emitted to the reflecting surface 370 is projected at a projection angle corresponding to the incident angle with respect to the reflecting surface 370. The 0th-order light L₀ is emitted to the dead region Z_{D} near the second mirror 36. The dead region Z_{D} is irradiated with the ghost image G_{A} of the desired light L_{A}, the ghost image G_{B} of the desired light L_{B}, and the ghost image G_{C} of the desired light L_{C}.

The ghost images G of the desired light L_{A}, the desired light L_{B}, and the desired light L_{C} appear at point-symmetric positions of the desired light L with the 0th-order light L₀ as the center. The first mirror 35, the second mirror 36, and the third mirror 37 are arranged while avoiding a region where the ghost image G is displayed. With such an arrangement, the 0th-order light L₀, the ghost image G_{A}, the ghost image G_{B}, and the ghost image G_{C} are not emitted to the reflecting surface 350 and the reflecting surface 360. In addition, the high-order light included in the modulated light 302 is emitted to the dead region Z_{D} deviated from the region illustrated in FIG. 15. Therefore, the 0th-order light L₀, the ghost image G_{A}, the ghost image G_{B}, the ghost image G_{C}, and the high-order light are not projected to the outside.

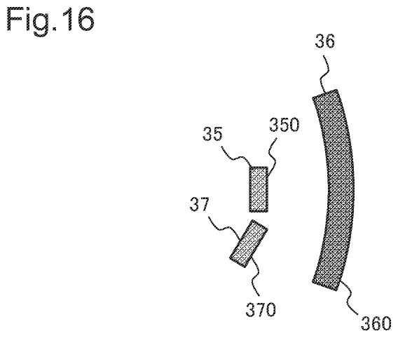

FIG. 16 is a conceptual diagram illustrating a positional relationship among the first mirror 35, the second mirror 36, and the third mirror 37. FIG. 16 is a cross-sectional view of the first mirror 35, the second mirror 36, and the third mirror 37 as viewed from above. In the plane of drawing of FIG. 16, the reflecting surface 350 of the first mirror 35 is directed rightward. Similarly, the reflecting surface 360 of the second mirror 36 is directed rightward. On the other hand, the reflecting surface 370 of the third mirror 37 is slightly inclined from the right (front) toward the periphery.

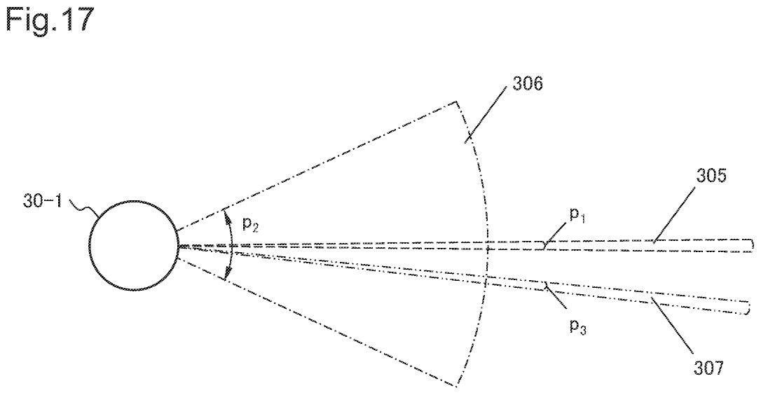

FIG. 17 is a conceptual diagram for describing spread of the projection light (spatial light signal) transmitted from a transmission device 30-1 of the present modified example. FIG. 17 is a diagram of the transmission device 30-1 as viewed from above. In the example of FIG. 17, the shape of the transmission device 30-1 is circular when viewed from above. FIG. 17 illustrates an example of the spread of the projection light in the plane of paper. The projection light also spreads in a direction perpendicular to the paper surface.

In FIG. 17, a projection range of the projection light 305 (broken line) reflected by the reflecting surface 350 of the first mirror 35 is a range of the first projection angle p₁. A projection range of the projection light 306 (one-dot chain line) reflected by the reflecting surface 360 of the second mirror 36 is a range of the second projection angle p₂. A projection range of the projection light 307 (two-dot chain line) reflected by the reflecting surface 370 of the third mirror 37 is a range of the third projection angle p₃. A projection range of the projection light 305, a projection range of the projection light 306, and a projection range of the projection light 307 overlap with each other.

When a plurality of flat mirrors are combined as in the present modification example, even in a case where a plurality of communication targets requires long-distance communication, communication with these communication targets can be performed simultaneously. The number of flat mirrors is not limited to two, and three or more flat mirrors may be disposed.

As described above, the transmission device according to the present example embodiment includes the light source, the spatial light modulator, the first mirror, the second mirror, and the control unit. The light source emits illumination light. The spatial light modulator includes a modulation part that modulates the illumination light emitted from the light source. The reflecting surface of the first mirror is a flat surface. The first mirror is disposed on the first optical path of the modulated light modulated by the modulation part. The first mirror is disposed at a position deviated from an optical path of unnecessary light included in the modulated light. The first mirror reflects the modulated light within the first projection range. The modulated light reflected by the first mirror is projected as the projection light toward the first projection range. The reflecting surface of the second mirror is a convex curved surface. The second mirror is disposed on the second optical path of the modulated light modulated by the modulation part. The second mirror is disposed at a position deviated from an optical path of unnecessary light included in the modulated light. The second mirror reflects the modulated light toward the second projection range around the first projection range. The modulated light reflected by the second mirror is projected as the projection light within the second projection range. The control unit sets a phase image used for spatial light communication in a modulation part of the spatial light modulator. The control unit controls the light source so that the modulation part is irradiated with light.

In the present example embodiment, a flat mirror in charge of the projection range (first projection range) at the center in the front and a curved mirror in charge of the projection range (second projection range) around the first projection range are combined. With such a configuration, according to the present example embodiment, it is possible to transmit a spatial light signal having a high energy density toward the front center direction. Therefore, according to the present example embodiment, regarding the front center direction, the spread of the projection light is suppressed as compared with the first example embodiment, and the reach distance of the projection light is further extended. That is, according to the present example embodiment, the effective communication distance of the spatial light signal can be extended in a specific direction.

A transmission device according to an aspect of the present example embodiment includes a third mirror having a flat reflecting surface. The third mirror is disposed on the third optical path of the modulated light modulated by the modulation part. The third mirror reflects the modulated light toward the third projection range within the range of the second projection range. The reflecting surface of the third mirror is directed in a direction different from the reflecting surface of the first mirror. In the present aspect, by combining the first mirror and the third mirror having the same projection distance as the projection distance of the first mirror, it is possible to transmit a spatial light signal having a long communication distance in two directions. For example, when the number of flat mirrors is further increased, a spatial light signal having a long communication distance can be transmitted in three or more directions.

### Fourth Example Embodiment

Next, a transmission device according to a fourth example embodiment will be described with reference to the drawings. The first mirror of the transmission device according to the present example embodiment has a concave reflecting surface. In this respect, the present example embodiment is different from the first example embodiment. The first mirror of the transmission device of the second to third example embodiments may be replaced with the first mirror of the present example embodiment.

### Configuration

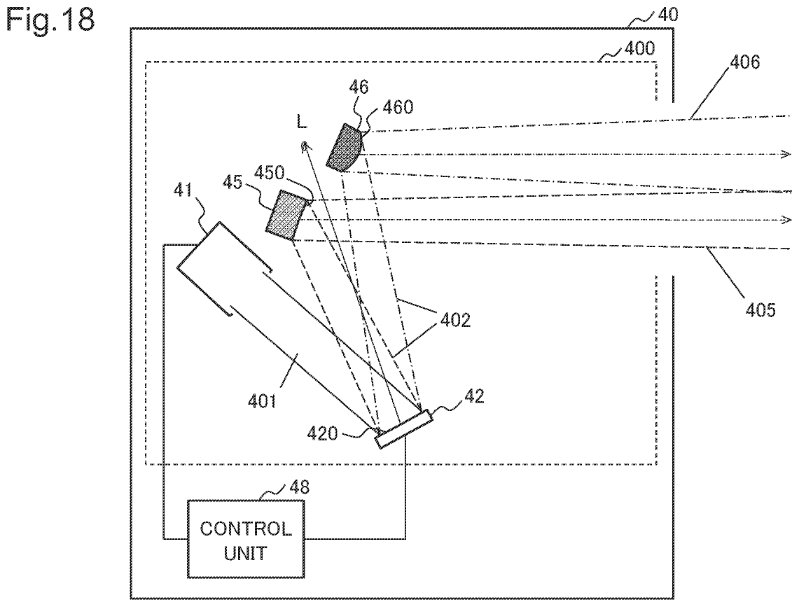

FIG. 18 is a conceptual diagram illustrating an example of a configuration of a transmission device 40 according to the present example embodiment. The transmission device 40 includes a light source 41, a spatial light modulator 42, a first mirror 45, a second mirror 46, and a control unit 48. The light source 41, the spatial light modulator 42, the first mirror 45, and the second mirror 46 constitute a transmitter 400. FIG. 18 is a conceptual diagram of the internal configuration of the transmission device 40 as viewed from the lateral direction. FIG. 18 is conceptual, and does not accurately represent the shape of each component, the positional relationship between components, the travel of light, and the like.

The light source 41 has the same configuration as the light source 11 of the first example embodiment. The light source 41 emits illumination light 401 under the control of the control unit 48. The light source 41 includes a light emitter and an optical system associated with the light emitter. The emission surface of the light source 41 is directed to the spatial light modulator 42. The light source 41 emits laser light (illumination light 401) in a predetermined wavelength band toward the spatial light modulator 42 under the control of the control unit 48.

The spatial light modulator 42 has the same configuration as the spatial light modulator 12 of the first example embodiment. The spatial light modulator 42 is a two-dimensional phase modulator. The spatial light modulator 42 includes a modulation part 420. At least one modulation region is set in the modulation part 420. In the example of FIG. 18, the first mirror 45 and the second mirror 46 are arranged at a subsequent stage of the spatial light modulator 42. For all the reflecting surfaces of the first mirror 45 and the second mirror 46, a common modulation region may be set, or different modulation regions may be allocated. The modulation part 420 in which the modulation region is set is irradiated with the illumination light 401 emitted from the light source.

In the modulation region set in the modulation part 420, a pattern (phase image) corresponding to the image displayed by the projection lights 405 to 406 is set according to the control of the control unit 48. The illumination light 401 incident on the modulation region set in the modulation part 420 is modulated according to the pattern (phase image) set in the modulation region. The modulated light 402 modulated in the modulation region travels toward the first mirror 45 and the second mirror 46 disposed at a subsequent stage.

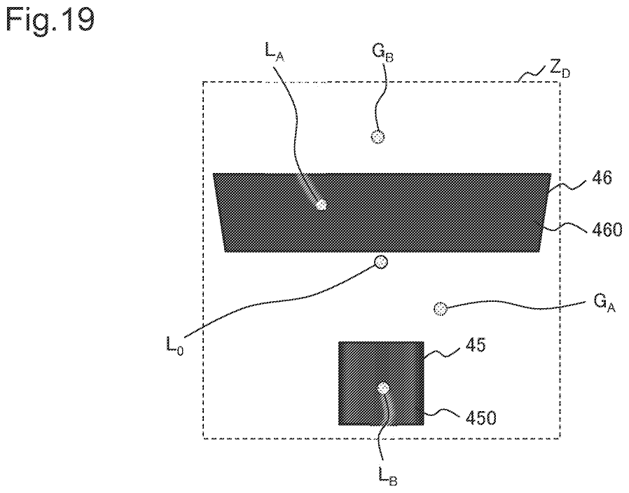

FIG. 19 is a conceptual diagram illustrating a positional relationship between the first mirror 45 and the second mirror 46. FIG. 19 is a conceptual diagram of the first mirror 45 and the second mirror 46 as viewed from the reflecting surface side. FIG. 19 illustrates a region (dead region Z_{D}) where the modulated light 402 is not reflected around the first mirror 45 and the second mirror 46. With respect to the region around the first mirror 45 and the second mirror 46, a region not illustrated as the dead region Z_{D} also corresponds to the dead region Z_{D}.

FIG. 19 illustrates an example of positions irradiated with the 0th-order light L₀, the desired light L_{A}, the desired light L_{B}, the ghost image G_{A}, and the ghost image G_{B}. The 0th-order light L₀ is 0th-order diffracted light included in the modulated light 402. The desired light L_{A} and the desired light L_{B} are first-order diffracted light included in the modulated light 402. The desired light L_{A} and the desired light L_{B} are light to be projected. The ghost image G_{A} is light that appears at a point-symmetrical position with respect to the desired light L_{A} with the 0th-order light L₀ as the center. The ghost image G_{B} is light that appears at a point-symmetrical position with respect to the desired light L_{B} with the 0th-order light L₀ as the center. The ghost image G_{A} and the ghost image G_{B} are unnecessary light components. Note that, although not illustrated in FIG. 19, the modulated light 402 includes second-order or higher diffracted light (high-order light).

In FIG. 19, the desired light L_{A} is emitted to the reflecting surface 460 of the second mirror 46. The desired light L_{A} emitted to the reflecting surface 460 is projected at a projection angle corresponding to the curvature of the reflecting surface 460. The desired light L_{B} is emitted to the reflecting surface 450 of the first mirror 45. The desired light L_{B} emitted to the reflecting surface 450 is projected at a projection angle corresponding to the curvature of the reflecting surface 450. The 0th-order light L₀ is emitted to the dead region Z_{D} near the second mirror 46. The dead region Z_{D} is irradiated with the ghost image G_{A} of the desired light L_{A} and the ghost image G_{B} of the desired light L_{B}.

The ghost image G of the desired light L appears at a point-symmetrical position of the desired light L with the 0th-order light L₀ as the center. The first mirror 45 and the second mirror 46 are arranged while avoiding a region where the ghost image G is displayed. With such an arrangement, the 0th-order light L₀, the ghost image G_{A}, and the ghost image G_{B} are not emitted to the reflecting surface 450 and the reflecting surface 460. In addition, the high-order light included in the modulated light 402 is emitted to the dead region outside the region illustrated in FIG. 19. Therefore, the 0th-order light L₀, the ghost image G_{A}, the ghost image G_{B}, and the high-order light are not projected to the outside.

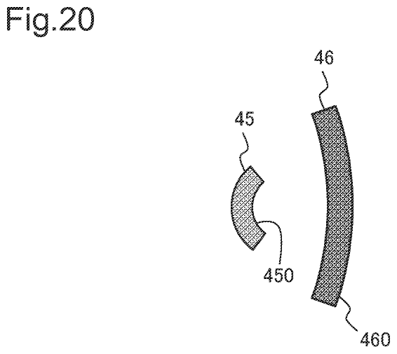

FIG. 20 is a conceptual diagram illustrating a positional relationship between the first mirror 45 and the second mirror 46. FIG. 20 is a cross-sectional view of the first mirror 45 and the second mirror 46 as viewed from above. In the plane of drawing of FIG. 20, the reflecting surface 450 of the first mirror 45 is directed rightward. Similarly, the reflecting surface 460 of the second mirror 46 is directed rightward. For example, as in a modification example of the third example embodiment, a mirror having a concave reflecting surface may be added.

The first mirror 45 is a curved mirror having a curved reflecting surface 450. The concave surface of the first mirror 45 is the reflecting surface 450. The reflecting surface 450 has a curvature corresponding to a projection angle of the projection light 405. The shape of the reflecting surface 450 is not limited as long as it includes a curved portion. For example, the reflecting surface 450 has the shape of a side surface of a cylinder. For example, the reflecting surface 450 may be a free-form surface or a spherical surface. For example, the reflecting surface 450 may have a shape obtained by combining a plurality of curved surfaces. For example, the reflecting surface 450 may have a shape obtained by combining a curved surface and a flat surface.

The first mirror 45 is disposed with the reflecting surface 450 facing the modulation part 420 of the spatial light modulator 42. The first mirror 45 is disposed on an optical path (first optical path) of the modulated light 402 modulated by the modulation part 420. The first mirror 45 is disposed while avoiding a position irradiated with an unnecessary light component (unnecessary light) included in the modulated light 402. The reflecting surface 450 is irradiated with light to be projected (desired light) in the modulated light 402. The modulated light 402 emitted to the reflecting surface 450 is reflected by the reflecting surface 450. The desired light reflected by the reflecting surface 450 is projected as the projection light 405.

The second mirror 46 is a curved mirror having a curved reflecting surface 460. The convex surface of the second mirror 46 is the reflecting surface 460. The reflecting surface 460 has a curvature corresponding to a projection angle of the projection light 406. The shape of the reflecting surface 460 is not limited as long as it includes a curved portion. For example, the reflecting surface 460 has the shape of a side surface of a cylinder. For example, the reflecting surface 460 may be a free-form surface or a spherical surface. For example, the reflecting surface 460 may have a shape obtained by combining a plurality of curved surfaces. For example, the reflecting surface 460 may have a shape obtained by combining a curved surface and a flat surface.

The second mirror 46 is disposed with the reflecting surface 460 facing the modulation part 420 of the spatial light modulator 42. The second mirror 46 is disposed on the second optical path of the modulated light 402 modulated by the modulation part 420. The second mirror 46 is disposed while avoiding a position irradiated with an unnecessary light component (unnecessary light) included in the modulated light 402. The reflecting surface 460 is irradiated with light to be projected (desired light) in the modulated light 402. The modulated light 402 emitted to the reflecting surface 460 is reflected by the reflecting surface 460. The desired light reflected by the reflecting surface 460 is enlarged at an enlargement ratio corresponding to the curvature of the reflecting surface 460 and projected as the projection light 406.

The projection light 405 and the projection light 406 are transmitted as a spatial light signal through a slit (not illustrated) opened in a housing of the transmission device 40. The projection light 405 and the projection light 406 spread as they go away from the transmission device 40. The projection light 406 is reflected by the reflecting surface 450 of the concave surface. Therefore, the projection light 406 has higher straightness than the projection light 405. The projection light 406 has higher straightness than the projection light 305 according to the third example embodiment. For example, a lens (not illustrated) for limiting the spread of the projection lights 405 to 406 or enlarging the spread of the projection lights 405 to 406 may be disposed at the subsequent stage of the first mirror 45 and the second mirror 46.

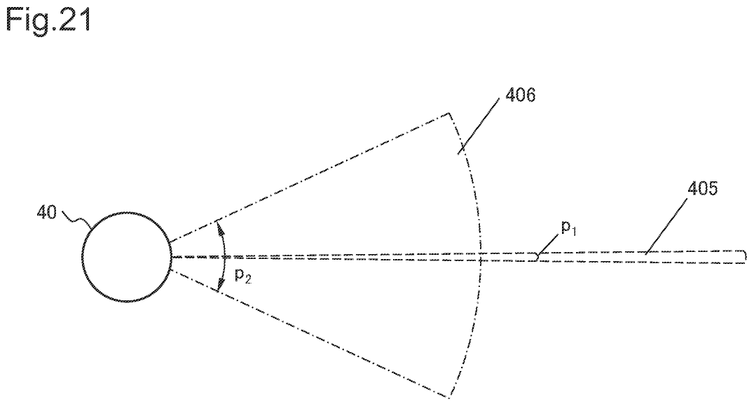

FIG. 21 is a conceptual diagram for explaining spread of the projection light (spatial light signal) transmitted from the transmission device 40. FIG. 21 is a diagram of the transmission device 40 as viewed from above. In the example of FIG. 21, the shape of the transmission device 40 is circular when viewed from above. FIG. 21 illustrates an example of the spread of the projection light in the plane of paper. The projection light also spreads in a direction perpendicular to the paper surface.

In FIG. 21, a projection range of the projection light 405 (broken line) reflected by the reflecting surface 450 of the first mirror 45 is a range of the first projection angle p₁. A projection range of the projection light 406 (one-dot chain line) reflected by the reflecting surface 460 of the second mirror 46 is a range of the second projection angle p₂. There is a region where the projection range of the projection light 405 and the projection range of the projection light 406 overlap.

The control unit 48 has the same configuration as the control unit 18 of the first example embodiment. The control unit 48 controls the light source 41 and the spatial light modulator 42. For example, the control unit 48 is achieved by a microcomputer including a processor and a memory. The control unit 48 sets a phase image corresponding to the projected image in the modulation part 420 in accordance with the aspect ratio of tiling set in the modulation part 420 of the spatial light modulator 42. The control unit 48 sets a phase image corresponding to the projected image in the modulation region set in the modulation part 420 of the spatial light modulator 42. For example, the control unit 48 sets, in the modulation part 420, a phase image corresponding to an image according to a use such as image display, communication, or distance measurement. The phase image of the projected image may be stored in advance in a storage unit (not illustrated). The shape and size of the image to be projected are not particularly limited.

The control unit 48 drives the light source 41 in a state where the phase image corresponding to the image to be displayed is set in the modulation part 420. As a result, the illumination light 401 emitted from the light source 41 is emitted to the modulation part 420 of the spatial light modulator 42 in accordance with the timing at which the phase image is set in the modulation part 420 of the spatial light modulator 42. The illumination light 401 emitted to the modulation part 420 of the spatial light modulator 42 is modulated by the modulation part 420 of the spatial light modulator 42. The modulated light 402 modulated by the modulation part 420 is emitted toward the first mirror 45 and the second mirror 46.

Furthermore, the control unit 48 modulates the illumination light 401 emitted from the light source 41 for communication with a communication target (not illustrated). In communication, the control unit 48 controls the timing at which the illumination light 401 is emitted from the light source 41 in a state where the phase image for communication is set in the modulation part 420 of the spatial light modulator 42. By such control, the illumination light 401 is modulated. The modulation pattern of the illumination light 401 in the communication is arbitrarily set. For example, a configuration for communication (communication unit) may be added separately from the control unit 48. In that case, the control unit 48 may be configured to control the light source 41 and the spatial light modulator 42 according to the condition set by the communication unit.

In the present example embodiment, since the overall projection angle depends on the projection light 406, the overall projection range is not widened. According to the present example embodiment, the projection light 405 having high energy density can be projected in the front direction with respect to the first mirror 45. The projection light 405 can have higher energy density than the projection light 305 of the third example embodiment. Therefore, according to the configuration of the present example embodiment, it is possible to extend the reach distance of the projection light while maintaining a wide projection range in a specific direction.

As described above, the transmission device according to the present example embodiment includes the light source, the spatial light modulator, the first mirror, the second mirror, and the control unit. The light source emits illumination light. The spatial light modulator includes a modulation part that modulates the illumination light emitted from the light source. The reflecting surface of the first mirror is a concave curved surface. The first mirror is disposed on the first optical path of the modulated light modulated by the modulation part. The first mirror is disposed at a position deviated from an optical path of unnecessary light included in the modulated light. The first mirror reflects the modulated light toward the first projection range. The modulated light reflected by the first mirror is projected as the projection light within the first projection range. The reflecting surface of the second mirror is a convex curved surface. The second mirror is disposed on the second optical path of the modulated light modulated by the modulation part. The second mirror is disposed at a position deviated from an optical path of unnecessary light included in the modulated light. The second mirror reflects the modulated light toward the second projection range around the first projection range. The modulated light reflected by the second mirror is projected as the projection light within the second projection range. The control unit sets a phase image used for spatial light communication in a modulation part of the spatial light modulator. The control unit controls the light source so that the modulation part is irradiated with light.

In the present example embodiment, a concave mirror in charge of the projection range (first projection range) at the center in the front and a curved mirror in charge of the projection range (second projection range) around the first projection range are combined. With such a configuration, according to the present example embodiment, it is possible to transmit a spatial light signal having a high energy density toward the front center direction. The concave mirror can reduce spread of the projection light as compared with the flat mirror. Therefore, according to the present example embodiment, regarding the front center direction, the spread of the projection light is suppressed as compared with the third example embodiment, and the reach distance of the projection light is further extended. That is, according to the present example embodiment, the effective communication distance of the spatial light signal can be extended in a specific direction.

### Fifth Example Embodiment

Next, a communication device according to a fifth example embodiment will be described with reference to the drawings. The communication device of the present example embodiment has a configuration in which a reception device and a transmission device are combined. The transmission device has the configuration of any one of the first to fourth example embodiments. The reception device receives the spatial light signal. Hereinafter, an example of a reception device having a light receiving function including a ball lens will be described. Note that the communication device of the present example embodiment may include a reception device including a light receiving function that does not include a ball lens.

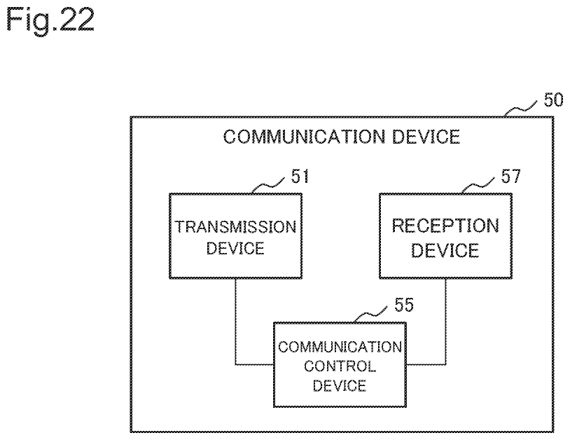

FIG. 22 is a conceptual diagram illustrating an example of a configuration of a communication device 50 according to the present example embodiment. The communication device 50 includes a transmission device 51, a communication control device 55, and a reception device 57. The communication device 50 transmits and receives spatial light signals to and from an external communication target. Therefore, an opening or a window for transmitting and receiving a spatial light signal is formed in the communication device 50.

The transmission device 51 is any one of the transmission devices of the first to fourth example embodiments. The transmission device 51 acquires a control signal from the communication control device 55. The transmission device 51 projects a spatial light signal according to the control signal. The spatial light signal projected from the transmission device 51 is received by a communication target (not illustrated) of a transmission destination of the spatial light signal.

The communication control device 55 acquires a signal output from the reception device 57. The communication control device 55 executes processing according to the acquired signal. The processing executed by the communication control device 55 is not particularly limited. The communication control device 55 outputs a control signal for transmitting an optical signal according to the executed processing to the transmission device 51. For example, the communication control device 55 executes processing based on a predetermined condition according to information included in the signal received by the reception device 57. For example, the communication control device 55 executes processing designated by the administrator of the communication device 50 according to information included in the signal received by the reception device 57.

The reception device 57 receives a spatial light signal transmitted from a communication target (not illustrated). The reception device 57 converts the received spatial light signal into an electrical signal. The reception device 57 outputs the converted electric signal to the communication control device 55. For example, the reception device 57 has a light receiving function including a ball lens. Furthermore, the reception device 57 may have a light receiving function that does not include a ball lens.

[Reception Device]

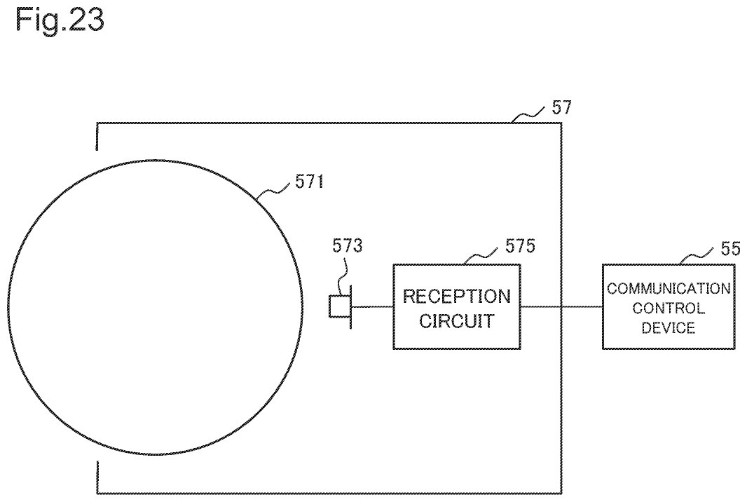

Next, a configuration of the reception device 57 will be described with reference to the drawings. FIG. 23 is a conceptual diagram for describing an example of a configuration of the reception device 57. The reception device 57 includes a ball lens 571, a light-receiving element 573, and a reception circuit 575. FIG. 23 is a side view of the internal configuration of the reception device 57 as viewed from the lateral direction. The position of the reception circuit 575 is not particularly limited. The reception circuit 575 may be disposed inside the reception device 57 or may be disposed outside the reception device 57. Furthermore, the function of the reception circuit 575 may be included in the communication control device 55.

The ball lens 571 is a spherical lens. The ball lens 571 is an optical element that collects a spatial light signal transmitted from a communication target. The ball lens 571 has a spherical shape when viewed from an arbitrary angle. A portion of the ball lens 571 protrudes from an opening opened in a housing of the reception device 57. The ball lens 571 collects the incident spatial light signal. The spatial light signal incident on the ball lens 571 protruding from the opening is collected. As long as the spatial light signal can be condensed, a portion of the ball lens 571 may not protrude from the opening.

The light (optical signal) derived from the spatial light signal condensed by the ball lens 571 is condensed toward the condensing region of the ball lens 571. Since the ball lens 571 has a spherical shape, the ball lens collects a spatial light signal arriving from an arbitrary direction. That is, the ball lens 571 exhibits similar light condensing performance for a spatial light signal arriving from an arbitrary direction. The light incident on the ball lens 571 is refracted when entering the inside of the ball lens 571. Furthermore, the light traveling inside the ball lens 571 is refracted again when being emitted to the outside of the ball lens 571. Most of the light emitted from the ball lens 571 is condensed in the condensing region.

For example, the ball lens 571 can be made of a material such as glass, crystal, or resin. In the case of receiving a spatial light signal in the visible region, the ball lens 571 can be achieved by a material such as glass, crystal, or resin that transmits/refracts light in the visible region. For example, the ball lens 571 can be achieved by optical glass such as crown glass or flint glass. For example, the ball lens 571 can be achieved by a crown glass such as BK (Boron Kron). For example, the ball lens 571 can be achieved by a flint glass such as Lanthanum Schwerflint (LaSF). For example, quartz glass can be applied to the ball lens 571. For example, a crystal such as sapphire can be applied to the ball lens 571. For example, a transparent resin such as acrylic can be applied to the ball lens 571.

In a case where the spatial light signal is light in a near-infrared region (hereinafter, near infrared rays), a material that transmits near-infrared rays is used for the ball lens 571. For example, in a case of receiving a spatial light signal in a near-infrared region of about 1.5 micrometers (μm), a material such as silicon can be applied to the ball lens 571 in addition to glass, crystal, resin, and the like. In a case where the spatial light signal is light in an infrared region (hereinafter, infrared rays), a material that transmits infrared rays is used for the ball lens 571. For example, in a case where the spatial light signal is an infrared ray, silicon, germanium, or a chalcogenide material can be applied to the ball lens 571. The material of the ball lens 571 is not limited as long as light in the wavelength region of the spatial light signal can be transmitted/refracted. The material of the ball lens 571 may be appropriately selected according to the required refractive index and use.

The ball lens 571 may be replaced with another concentrator as long as the spatial light signal can be condensed toward the region where the light-receiving element 573 is disposed. For example, the ball lens 571 may be a light beam control element that guides the incident spatial light signal toward the light-receiving portion of the light-receiving element 573. For example, the ball lens 571 may have a configuration in which a lens or a light beam control element is combined. For example, a mechanism that guides the optical signal condensed by the ball lens 571 toward the light-receiving portion of the light-receiving element 573 may be added.

The light-receiving element 573 is disposed at a subsequent stage of the ball lens 571. The light-receiving element 573 is disposed in the condensing region of the ball lens 571. The light-receiving element 573 includes a light-receiving portion that receives the optical signal collected by the ball lens 571. The light signal collected by the ball lens 571 is received by the light-receiving portion of the light-receiving element 573. The light-receiving element 573 converts the received optical signal into an electric signal (hereinafter, a signal). The light-receiving element 573 outputs the converted signal to the reception circuit 575. FIG. 23 illustrates an example in which the light-receiving element 573 is a single element. For example, the plurality of light-receiving elements 573 may be arranged in the condensing region of the ball lens 571. For example, a light-receiving element array in which a plurality of light-receiving elements 573 is arrayed may be arranged in the condensing region of the ball lens 571.

The light-receiving element 573 receives light in a wavelength region of the spatial light signal to be received. For example, the light-receiving element 573 has sensitivity to light in the visible region. For example, the light-receiving element 573 has sensitivity to light in an infrared region. The light-receiving element 573 is sensitive to light having a wavelength in a 1.5 μm (micrometer) band, for example. Note that the wavelength band of light to which the light-receiving element 573 is sensitivity is not limited to the 1.5 μm band. The wavelength band of the light received by the light-receiving element 573 can be arbitrarily set in accordance with the wavelength of the spatial light signal to be received. The wavelength band of the light received by the light-receiving element 573 may be set to, for example, a 0.8 μm band, a 1.55 μm band, or a 2.2 μm band. Furthermore, the wavelength band of the light received by the light-receiving element 573 may be, for example, a 0.8 to 1 μm band. A shorter wavelength band is advantageous for optical spatial communication during rainfall because absorption by moisture in the atmosphere is small. In addition, if the light-receiving element 573 is saturated with intense sunlight, the light-receiving element cannot read the optical signal derived from the spatial light signal. Therefore, a color filter that selectively passes the light of the wavelength band of the spatial light signal may be installed at the preceding stage of the light-receiving element 573.

For example, the light-receiving element 573 can be achieved by an element such as a photodiode or a phototransistor. For example, the light-receiving element 573 is achieved by an avalanche photodiode. The light-receiving element 573 achieved by the avalanche photodiode can support high-speed communication. Note that the light-receiving element 573 may be achieved by an element other than a photodiode, a phototransistor, or an avalanche photodiode as long as an optical signal can be converted into an electric signal. In order to improve the communication speed, the light-receiving portion of the light-receiving element 573 is preferably as small as possible. For example, the light-receiving portion of the light-receiving element 573 has a square light-receiving surface having a side of about 5 mm (mm). For example, the light-receiving portion of the light-receiving element 573 has a circular light-receiving surface having a diameter of about 0.1 to 0.3 mm. The size and shape of the light-receiving portion of the light-receiving element 573 may be selected according to the wavelength band, the communication speed, and the like of the spatial light signal.

For example, a polarizing filter (not illustrated) may be disposed in front of the light-receiving element 573. The polarizing filter is disposed in association with the light-receiving portion of the light-receiving element 573. For example, the polarizing filter is disposed to overlap the light-receiving portion of the light-receiving element 573. For example, the polarization filter may be selected according to the polarization state of the spatial light signal to be received. For example, when the spatial light signal to be received is linearly polarized light, the polarizing filter includes a ½ wave plate. For example, when the spatial light signal to be received is circularly polarized light, the polarizing filter includes a ¼ wave plate. The polarization state of the optical signal having passed through the polarizing filter is converted according to the polarization characteristic of the polarizing filter.

The reception circuit 575 acquires a signal output from the light-receiving element 573. The reception circuit 575 amplifies the signal from the light-receiving element 573. The reception circuit 575 decodes the amplified signal. The signal decoded by the reception circuit 575 is used for any purpose. The use of the signal decoded by the reception circuit 575 is not particularly limited.

[Communication Device]

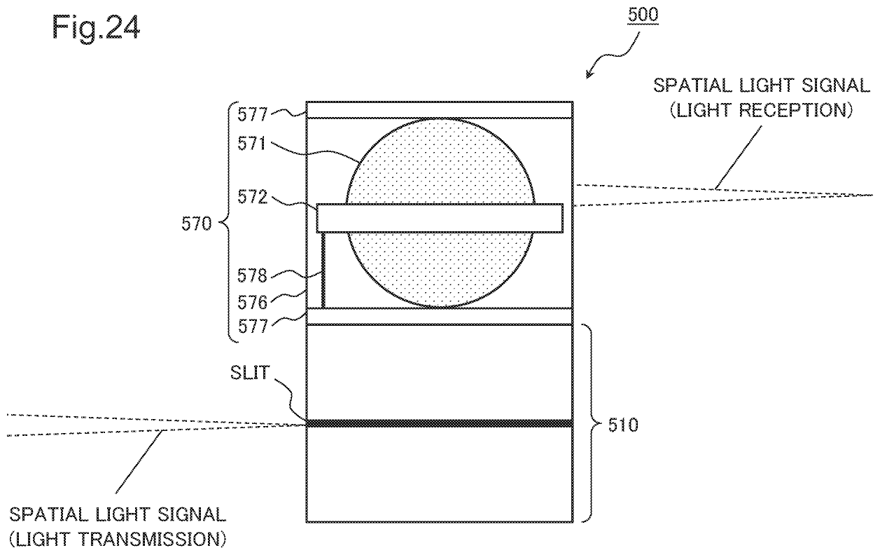

FIG. 24 is a conceptual diagram illustrating an example (communication device 500) of the communication device 50. The communication device 500 includes a transmitter 510, a receiver 570, and a communication control device (not illustrated). In FIG. 24, a reception circuit and a communication control device are omitted. The reception circuit and the communication control device are disposed inside the communication device 500. The communication device 500 has a configuration in which the transmitter 510 having a cylindrical outer shape and the receiver 570 are combined.

The receiver 570 includes a ball lens 571, a light receiver 572, a color filter 576, and a support member 577. The upper and lower portions of the ball lens 571 are sandwiched between a pair of support members 577 arranged vertically. Since the upper and lower sides of the ball lens 571 are not used for transmission and reception of spatial light signals, they may be processed into a planar shape so as to be easily sandwiched by the support member 577. The light receiver 572 is arranged in accordance with the condensing region of the ball lens 571 so as to be able to receive the spatial light signal to be received. The light receiver 572 includes a light-receiving element array in which a plurality of light-receiving elements is annularly arranged. The plurality of light-receiving elements are arranged in the condensing region of the ball lens 571. The plurality of light-receiving elements are arranged with the light-receiving portion facing the ball lens 571. The plurality of light-receiving elements are connected to a control device (not illustrated) and the transmitter 510 by a conductive wire 578.

The color filter 576 is disposed on a side surface of the cylindrical receiver 570. The color filter 576 removes unnecessary light and selectively transmits a spatial light signal used for communication. A pair of support members 577 is disposed on upper and lower surfaces of the cylindrical receiver 570. The pair of support members 577 sandwich the ball lens 571 from above and below. A light receiver 572 formed in an annular shape is arranged around the ball lens 571. The light receiver 572 includes a plurality of light-receiving elements in which the light receiver faces the ball lens 571. The spatial light signal incident on the ball lens 571 through the color filter 576 is condensed toward the light receiver 572 by the ball lens 571. The optical signal condensed on the light receiver 572 is guided toward the light-receiving portion of one of the light-receiving elements. The light signal reaching the light-receiving portion of the light-receiving element is received by the light-receiving element. A communication control device (not illustrated) decodes an optical signal received by a light-receiving element included in the light receiver 572. The communication control device causes the transmitter 510 to transmit the spatial light signal according to the decoded optical signal.

The transmitter 510 is configured by any one of the transmission devices of the first to fourth example embodiments. The transmitter 510 is housed inside a cylindrical housing. A slit opened in accordance with the transmission direction of the spatial light signal by the transmitter 510 is formed in the cylindrical housing. For example, in a case where the transmitter 510 can transmit the spatial light signal in the direction of 360 degrees, a slit is formed on the side surface of the housing of the transmitter 510 in accordance with the transmission direction of the spatial light signal.

### Application Example

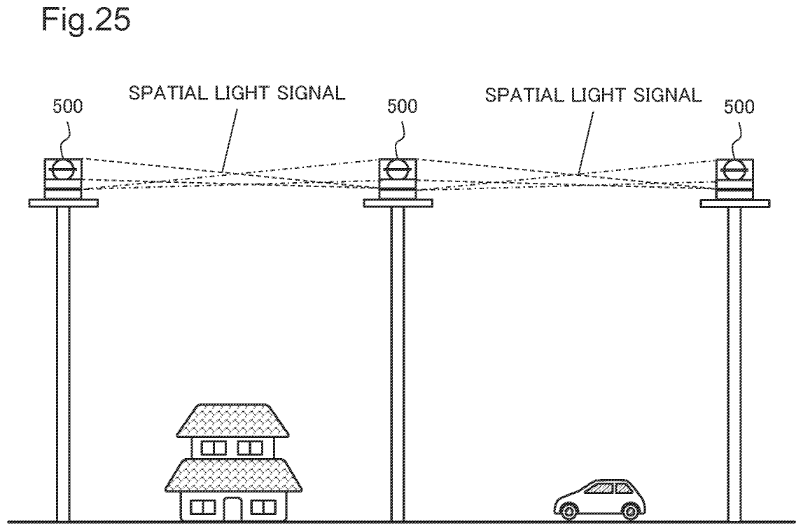

Next, an application example of the present example embodiment will be described with reference to the drawings. In the following application example, an example in which a plurality of communication devices 500 transmit and receive spatial light signals will be described. FIG. 25 is a conceptual diagram for describing the present application. In the present application example, an example (communication system) of a communication network in which a plurality of communication devices 500 is arranged on an upper portion (space above a pole) of a pole such as a utility pole or a street lamp arranged in a town will be described.

There are few obstacles in the space above the pole. Therefore, the space above the pole is suitable for installing the communication device 500. In addition, if the communication device 500 is installed at the same height, the arrival direction of the spatial light signal is limited to the horizontal direction. Therefore, the light-receiving area of the light receiver constituting the receiver 570 can be reduced, and the device can be simplified. The pair of communication devices 500 that transmit and receive the spatial light signal is arranged such that at least one communication device 500 receives the spatial light signal transmitted from the other communication device 500. The pair of communication devices 500 may be arranged to transmit and receive spatial light signals to and from each other. In a case where the communication network of the spatial light signal is configured by the plurality of communication devices 500, the communication device 500 positioned in the middle may be arranged to relay the spatial light signal transmitted from another communication device 500 to another communication device 500.

According to the present application example, communication using a spatial light signal can be performed among the plurality of communication devices 500 arranged in the space above a pole. For example, communication by wireless communication may be performed between a wireless device or a base station installed in an automobile, a house, or the like and the communication device 500 according to communication between the communication devices 500. For example, the communication device 500 may be connected to the Internet via a communication cable or the like installed on a pole.

As described above, the communication device according to the present example embodiment includes the reception device, the transmission device, and the communication control device. The transmission device is at least one of the transmission devices (transmitters) according to the first to fourth example embodiments. The reception device receives a spatial light signal from another communication device. The communication control device acquires a signal based on a spatial light signal from another communication device received by the reception device. The communication control device executes processing according to the acquired signal. The communication control device causes the transmission device to transmit a spatial light signal corresponding to the executed processing.

A transmission device included in a communication device according to the present example embodiment projects projection light using two mirrors disposed at positions deviated from an optical path of unnecessary light included in modulated light. According to the transmission device of the present example embodiment, using the two mirrors, the projection range can be expanded without lowering the energy density of the projection light. Therefore, according to the present example embodiment, it is possible to extend the effective communication distance of the spatial light signal while securing a sufficient projection range.

A communication system according to an aspect of the present example embodiment includes a plurality of the above-described communication devices. In a communication system, a plurality of communication devices are arranged to transmit and receive spatial light signals to and from each other. According to the present aspect, it is possible to realize a communication network that transmits and receives a spatial light signal.

### Sixth Example Embodiment

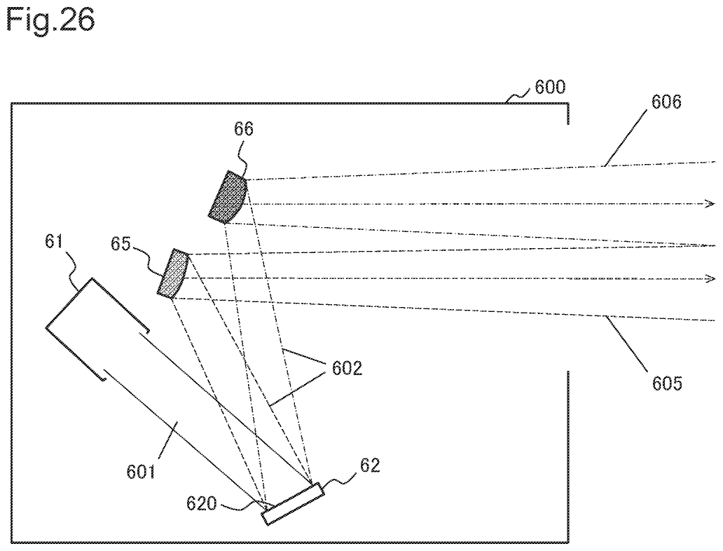

Next, a transmitter according to a sixth example embodiment will be described with reference to the drawings. The transmitter of the present example embodiment has a simplified configuration of the transmitters included in the transmission devices of the first to fourth example embodiments. FIG. 26 is a conceptual diagram illustrating an example of a configuration of a transmitter 600 according to the present example embodiment. FIG. 26 is a side view of the internal configuration of the transmitter 600 as viewed from the lateral direction. The transmitter 600 includes a light source 61, a spatial light modulator 62, a first mirror 65, and a second mirror 66. Shapes and positional relationships of the light source 61, the spatial light modulator 62, the first mirror 65, and the second mirror 66 are conceptual, and are not accurately described.

The light source 61 emits illumination light 601. The spatial light modulator 62 includes a modulation part 620 that modulates the illumination light 601 emitted from the light source 61. The first mirror 65 is disposed on the first optical path of the modulated light 602 modulated by the modulation part 620. The first mirror 65 is disposed at a position deviated from an optical path of unnecessary light included in the modulated light 602. The first mirror 65 reflects modulated light 602 toward the first projection range. The modulated light 602 reflected by first mirror 65 is projected as the projection light 605 within the first projection range. The second mirror 66 is disposed on the second optical path of the modulated light 602 modulated by the modulation part 620. The second mirror 66 is disposed at a position deviated from an optical path of unnecessary light included in the modulated light 602. The second mirror 66 reflects modulated light 602 toward the second projection range around the first projection range. The modulated light 602 reflected by second mirror 66 is projected as the projection light 606 within the second projection range.

In the present example embodiment, the projection light is projected using two mirrors arranged at positions deviated from an optical path of unnecessary light included in modulated light. According to the present example embodiment, using the two mirrors, the projection range can be expanded without lowering the energy density of the projection light. Therefore, according to the present example embodiment, it is possible to extend the effective communication distance of the spatial light signal while securing a sufficient projection range.

### Hardware

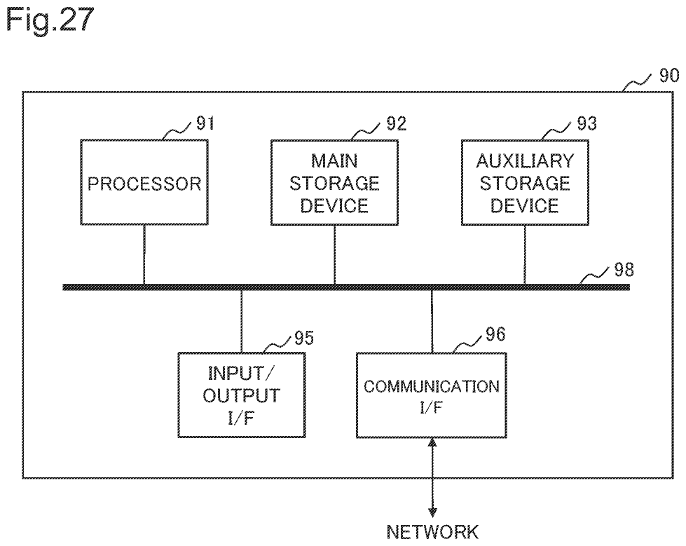

Here, a hardware configuration for executing control and processing according to each example embodiment of the present disclosure will be described using an information processing device 90 (computer) of FIG. 27 as an example. Note that the information processing device 90 in FIG. 27 is a configuration example for executing control and processing of each example embodiment, and does not limit the scope of the present disclosure.

As illustrated in FIG. 27, the information processing device 90 includes a processor 91, a main storage device 92, an auxiliary storage device 93, an input/output interface 95, and a communication interface 96. In FIG. 27, the interface is abbreviated as an interface (I/F). The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops a program (instruction) stored in the auxiliary storage device 93 or the like in the main storage device 92. For example, the program is a software program for executing control and processing of each example embodiment. The processor 91 executes the program developed in the main storage device 92. The processor 91 executes the program to execute control and processing according to each example embodiment.

The main storage device 92 has an area in which a program is developed. A program stored in the auxiliary storage device 93 or the like is developed in the main storage device 92 by the processor 91. The main storage device 92 is, for example, a volatile memory such as a dynamic random access memory (DRAM). A nonvolatile memory such as a magnetoresistive random access memory (MRAM) may be configured and added as the main storage device 92.

The auxiliary storage device 93 stores various types of data such as programs. The auxiliary storage device 93 is a local disk such as a hard disk or a flash memory. Various types of data may be stored in the main storage device 92, and the auxiliary storage device 93 may be omitted.

The input/output interface 95 is an interface for connecting the information processing device 90 and a peripheral device based on a standard or a specification. The communication interface 96 is an interface for connecting to an external system or device through a network such as the Internet or an intranet based on a standard or a specification. The input/output interface 95 and the communication interface 96 may be shared as an interface connected to an external device.

Input devices such as a keyboard, a mouse, and a touch panel may be connected to the information processing device 90 as necessary. These input devices are used for inputting information and settings. When a touch panel is used as the input device, a screen having a touch panel function serves as an interface. The processor 91 and the input device are connected via the input/output interface 95.

The information processing device 90 may be provided with a display device for displaying information. In a case where a display device is provided, the information processing device 90 includes a display control device (not illustrated) for controlling display of the display device. The information processing device 90 and the display device are connected via the input/output interface 95.

The information processing device 90 may be provided with a drive device. The drive device mediates reading of data and a program stored in a recording medium and writing of a processing result from the information processing device 90 to the recording medium between the processor 91 and the recording medium (program recording medium). The information processing device 90 and the drive device are connected via an input/output interface 95.

The above is an example of a hardware configuration for enabling control and processing according to each example embodiment of the present invention. The hardware configuration of FIG. 27 is an example of a hardware configuration for executing control and processing according to each example embodiment, and does not limit the scope of the present invention. A program for causing a computer to execute control and processing according to each example embodiment is also included in the scope of the present invention.

A program recording medium in which the program according to each example embodiment is recorded is also included in the scope of the present invention. The recording medium can be achieved by, for example, an optical recording medium such as a compact disc (CD) or a digital versatile disc (DVD). The recording medium may be a semiconductor recording medium such as a universal serial bus (USB) memory or a secure digital (SD) card. The recording medium may be a magnetic recording medium such as a flexible disk, or another recording medium. In a case where the program executed by the processor is recorded in the recording medium, the recording medium corresponds to a program recording medium.

The components of the example embodiments may be arbitrarily combined. The components of the example embodiments may be implemented by software. The components of each example embodiment may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A transmitter comprising:
a light source;
a spatial light modulator including a modulation part that modulates illumination light emitted from the light source;
a first mirror that is disposed on a first optical path of modulated light modulated by the modulation part and reflects the modulated light toward a first projection range; and
a second mirror that is disposed on a second optical path of the modulated light modulated by the modulation part and reflects the modulated light toward a second projection range around the first projection range, wherein
the first mirror and the second mirror are disposed at positions deviated from an optical path of unnecessary light included in the modulated light.

2. The transmitter according to claim 1, wherein
the first mirror and the second mirror are arranged while avoiding a position irradiated with a ghost image of desired light included in the unnecessary light and a position irradiated with 0th-order light included in the unnecessary light.

3. The transmitter according to claim 2, wherein
reflecting surfaces of the first mirror and the second mirror are convex curved surfaces,
the second mirror is divided into two reflecting surfaces with a bent portion as a boundary, and
the two reflecting surfaces of the second mirror are inclined from a front center toward a periphery with respect to the reflecting surface of the first mirror.

4. The transmitter according to claim 3, further comprising:
a third mirror that is disposed on a third optical path of the modulated light modulated by the modulation part and reflects the modulated light toward a third projection range around the second projection range, wherein
a reflecting surface of the third mirror is a convex curved surface, and is divided into two reflecting surfaces with a bent portion as a boundary, and
the two reflecting surfaces of the third mirror are inclined with respect to the reflecting surface of the first mirror from a front center toward a periphery more than the reflecting surface of the second mirror.

5. The transmitter according to claim 2, wherein
a reflecting surface of the first mirror is a flat surface, and
a reflecting surface of the second mirror is a convex curved surface.

6. The transmitter according to claim 5, further comprising:
a third mirror having a flat reflecting surface, disposed in a third optical path of the modulated light modulated by the modulation part, and reflecting the modulated light toward a third projection range within a range of the second projection range, wherein
a reflecting surface of the third mirror is directed in a direction different from the reflecting surface of the first mirror.

7. The transmitter according to claim 2, wherein
a reflecting surface of the first mirror is a concave curved surface, and
a reflecting surface of the second mirror is a convex curved surface.

8. A transmission device comprising:
the transmitter according to claim 1;
a memory storing instructions; and
a processor connected to the memory and configured to execute the instructions to
set a phase image used for spatial light communication in a modulation part of a spatial light modulator included in the transmitter, and
control a light source included in the transmitter such that the modulation part is irradiated with the illumination light.

9. A communication device comprising:
a transmission device including the transmitter according to claim 1;
a reception device that receives a spatial light signal from another communication device; and
a communication control device that comprises a memory storing instructions; and
a processor connected to the memory and configured to execute the instructions to
acquire a signal based on the spatial light signal received by the reception device,
execute processing according to the acquired signal, and
cause the transmission device to transmit a spatial light signal according to the executed processing.

10. A communication system comprising:
a plurality of the communication devices according to claim 9, wherein
the plurality of the communication devices are arranged to transmit and receive spatial light signals to and from each other.
